(19) United States
(12) Patent Application Publication
(10) Pub. No.: US 2003/0091945 A1
(43) Pub. Date: May 15, 2003

(54) Silver halide color photographic material and method of reducing magenta stain

(75) Inventors: Yasuhiro Kato, Kanagawa (JP); Hisashi Mikoshiba, Kanagawa (JP); Naoto Matsuda, Kanagawa (JP)

Correspondence Address: Sughrue Mion, PLLC, 2100 Pennsylvania Avenue, N.W., Washington, DC, 20037-3213, US

(73) Assignee: FUJI PHOTO FILM CO., LTD.

(21) Appl. No.: 10/134,614

(22) Filed: Apr. 30, 2002

(30) Foreign Application Priority Data
May 1, 2001 (JP) 2001-134591

(51) Int. Cl. G03C 1/34; G03C 7/32

(52) U.S. Cl. 430/551; 430/558

(57) ABSTRACT

A silver halide color photographic material comprises a lightsensitive emulsion layer on a support. The material contains a cyan coupler of formula (CC-1) and a compound of formulas (SC-I) to (SC-V):

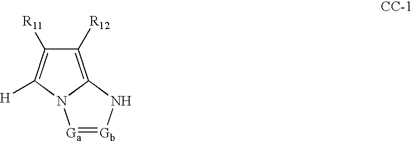

wherein Ga and Gb represent —C(R₁₃)═ or —N═; R₁₁ and R₁₂ represents an electron-withdrawing group having σp of 0.20 to 1.0; and R₁₃ represents a substituent;

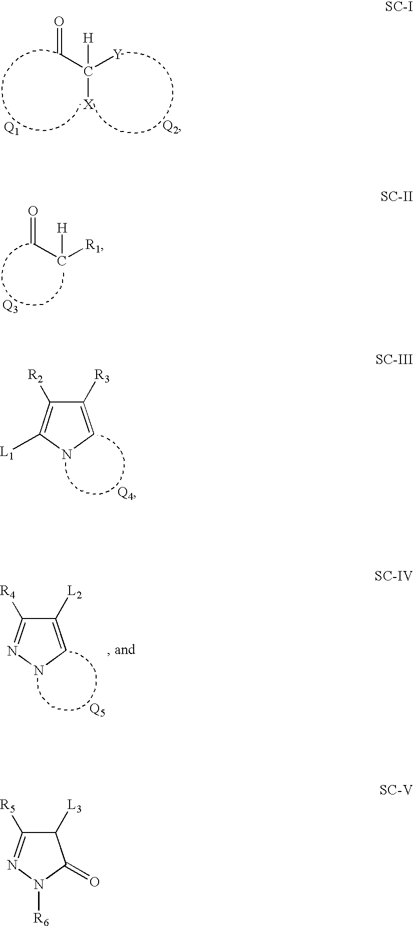

wherein Q₁, Q₂ Q₃, Q₄, Q₅ represent a non-metallic atomic group capable of forming a 5- or 6-membered ring; Y represents a carbonyl or sulfonyl group; X represents C—Rₓ or N, wherein Rₓ represents a hydrogen atom or substituent; R₁ represents an aryl or substituted carbonyl group; R₂, R₃, R₄, R₅ and R₆ represent a substituent; and L₁, L₂ and L₃ represent a group that does not leave in its reaction with an aromatic primary amine color developer.

### CROSS-REFERENCE TO RELATED APPLICATIONS

This application is based upon and claims the benefit of priority from the prior Japanese Patent Application No. 2001-134591, filed May 1, 2001, the entire contents of which are incorporated herein by reference.

### BACKGROUND OF THE INVENTION

1. Field of the Invention

The present invention relates to a silver halide color photographic material, and particularly, to a silver halide color photographic material with improved color reproduction.

Further, the present invention relates also to a method of reducing magenta stain of a silver halide color photographic material.

2. Description of the Related Art

Color reproduction is an important performance of silver halide color photographic materials. Silver halide color photographic materials generally form a full color image with image-forming dyes of three colors, i.e., yellow, magenta and cyan. In the field of so-called conventional color materials, it is general to use, for image forming, an image-forming coupler capable of reacting with an aromatic primary amine developing agent in an oxidized form to form a dye.

As a cyan coupler for forming a cyan dye, phenol derivatives have heretofore been used generally. However, this kind of coupler has adverse side absorption in a region from magenta to yellow. On the other hand, as a cyan coupler with less side absorption, pyrrolotriazole-based cyan couplers are disclosed in, for example, Jpn. Pat. Appln. KOKAI Publication No. (hereinafter referred to as JP-A-) 5-313324 and JP-A-6-347960.

To use a coupler capable of forming a dye with good hue is favorable for any silver halide color photographic material. However, the inventors of the present invention found, after their investigation, a problem that if a four equivalent pyrrolotriazole coupler having a hydrogen atom as a group to be released through coupling is color developed with a color developer containing an aromatic primary amine developing agent and then is post-processed with a liquid containing formalin or its derivative, the image obtained after the processing is colored into magenta in a white background thereof during its storage period. The fact that a white background gets colored during image storage means a great deterioration of quality of a product. Because of this problem, practical use of the four equivalent pyrrolotriazole coupler is still a difficult subject.

In this industry, to improve the image storability problems, such as the coloring of a white background and color dye fading, has been widely carried out by use of additives (for example, a color image stabilizer). As examples of a color image stabilizer for a pyrrolotriazole cyan coupler, combinations with hydroquinones and with sulfonaminde phenols are disclosed in JP-A's-5-333501 and 10-3147, and a combination with hydrazines is disclosed in JP-A-5-232651. Further, JP-A-8-278613 discloses a combination with a 1,2-dialkoxyphenol derivative or with a 4-alkoxyaniline derivative.

On the other hand, JP-A's-9-80708 and 9-222710, for example, disclose a processing method in which a four equivalent pyrrolotriazole cyan coupler is color developed and then a post processing is carried out using a liquid containing an 1-donor.

However, no description about the problem of magenta stain in a white background can be found in these publications of patent applications. Therefore, nobody has hitherto known the fact that there is such a problem with a four equivalent pyrrolotriazole coupler, and also no method of improving this problem has been known. JP-A's 9-80708 and 9-222710 disclose, in their example sections, a method in which a material containing a hydrazine derivative together with a four equivalent pyrrolotriazole coupler is post-processed with a liquid containing a formalin donor. However, the hydrazine derivatives disclosed therein can solve that problem only to an unsatisfactory extent, and therefore, an effective measure for improvement has been demanded.

### BRIEF SUMMARY OF THE INVENTION

An object of the present invention is to provide a silver halide color photographic material having good color reproduction and excellent image storability.

Another object of the present invention is to provide a method of reducing magenta stain of a silver halide color photographic material by which method images with good color reproduction and excellent storability can be formed.

The objects of the present invention were attained by the following constructions.

(1) A silver halide color photographic material comprising at least one lightsensitive emulsion layer on a support, wherein the material contains

at least one cyan coupler represented by the following general formula (CC-1) and at least one compound selected from the group consisting of compounds represented by the following general formulas (SC-I), (SC-II), (SC-III), (SC-IV) and (SC-V):

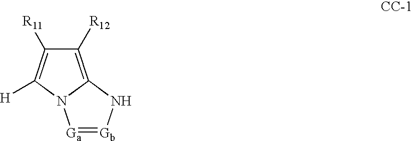

In general formula (CC-1), Ga and Gb represent —C(R₁₃)═ or —N═, provided that when Ga represents —N═, Gb represents —C(R₁₃)═ and when Ga represents —C(R₁₃)═, Gb represents —N═.

Each of R₁₁ and R₁₂ represents an electron-withdrawing group having a Hammett substituent constant σp of 0.20 or more and 1.0 or less. R₁₃ represents a substituent.

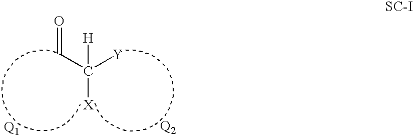

In general formula (SC-I), Y represents a carbonyl group or a sulfonyl group. Q₁ and Q₂ each represent a substituted or unsubstituted non-metallic atomic group capable of forming a 5- or 6-membered ring. X represents C—Rₓ or a nitrogen atom, wherein Rₓ represents a hydrogen atom or a substituent.

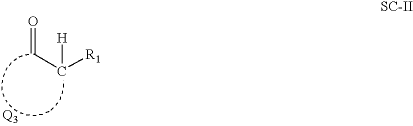

In general formula (SC-II), Q₃ represents a substituted or unsubstituted non-metallic atomic group capable of forming a 5- or 6-membered ring. R₁ represents a substituted or unsubstituted aryl group or a substituted carbonyl group.

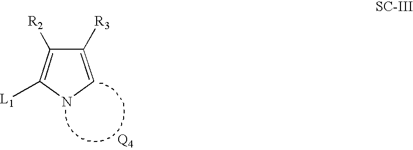

In general formula (SC-III), Q₄ represents a substituted or unsubstituted non-metallic atomic group capable of forming a 5- or 6-membered ring. R₂ and R₃ each represent a substituent. L₁ represents a group that does not leave in its reaction with an aromatic primary amine color developing agent.

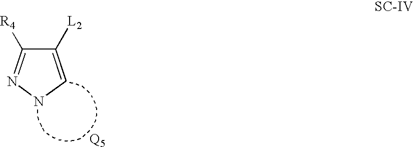

In general formula (SC-IV), Q₅ represents a substituted or unsubstituted non-metallic atomic group capable of forming a 5- or 6-membered ring. R₄ represents a substituent. L₂ represents a group that does not leave in its reaction with an aromatic primary amine color developing agent.

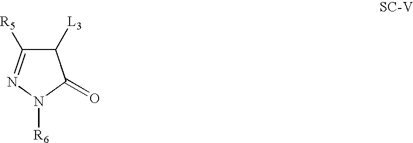

In general formula (SC-V), R₅ and R₆ each represent a substituent. L₃ represents a group that does not leave in its reaction with an aromatic primary amine color developing agent.

(2) A method of reducing magenta stain in a silver halide color photographic material, wherein the method comprises allowing a silver halide color photographic material comprising at least one lightsensitive emulsion layer on a support to contain at least one cyan coupler represented by the above general formula (CC-1) and at least one compound selected from the group consisting of compounds represent by the above general formulas (SC-I), (SC-II), (SC-III), (SC-IV) and (SC-V).

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DETAILED DESCRIPTION OF THE INVENTION

The present invention will be described in detail below.

First, general formula (CC-1) is explained.

In general formula (CC-1), Ga represents —C(R₁₃)═ or —N═. If Ga represents —N═, Gb represents —C(R₁₃)═. On the other hand, if Ga represents —C(R₁₃)═, Gb represents —N═.

Although both R₁₁ and R₁₂ are an electron-withdrawing group each having a Hammett substituent constant σp of 0.20 or more and 1.0 or less, it is desirable that the sum of the op values of R₁₁ and R₁₂ is 0.65 or more. The coupler of the present invention has an excellent performance as a cyan coupler because of such strong electron-withdrawing groups introduced. The sum of the σp values of R₁₁ and R₁₂ is preferably 0.70 or more and the upper limit thereof is about 1.8.

In the present invention, each of R₁₁ and R₁₂ is an electron-withdrawing group with a Hammett substituent constant σp value (to be simply referred to as a σp value hereinafter) of 0.20 to 1.0, preferably an electron-withdrawing group having a σp value of 0.30 to 0.8. The Hammett's rule is an empirical rule proposed by L. P. Hammett in 1935 in order to quantitatively argue the effects of substituents on reaction or equilibrium of benzene derivatives. The rule is widely regarded as appropriate in these days. The substituent constants obtained by the Hammett rule include a σp value and a σm value, and these values are described in a large number of general literature. For example, the values are described in detail in J. A. Dean ed., “Lange's Hand Book of Chemistry,” the 12th edition, 1979 (McGraw-Hill), “KAGAKU NO RYOUIKI ZOUKANN (The Extra Number of The Domain of Chemistry),” Vol. 122, pages 96 to 103, 1979 (Nanko Do) and Chemical Reviews, vol. 91, pp.165-195 (1991). In the present invention, each of R₁₁ and R₁₂ is defined by the Hammett substituent constant σp value. However, this does not mean that R₁₁ and R₁₂ are limited to substituents having the already known values described in these literature. That is, the present invention includes, of course, substituents having values that fall within the above range when measured on the basis of the Hammett's rule even if they are unknown in literature.

Practical examples of R₁₁ and R₁₂, as the electron-withdrawing group with a σp value of 0.20 to 1.0, are an acyl group, acyloxy group, carbamoyl group, aliphatic oxycarbonyl group, aryloxycarbonyl group, cyano group, nitro group, dialkylphosphono group, diarylphosphono group, diarylphosphinyl group, alkylsulfinyl group, arylsulfinyl group, alkylsulfonyl group, arylsulfonyl group, sulfonyloxy group, acylthio group, sulfamoyl group, thiocyanate group, thiocarbonyl group, alkyl group substituted by at least two halogen atoms, alkoxy group substituted by at least two halogen atoms, aryloxy group substituted by at least two halogen atoms, alkylamino group substituted by at least two halogen atoms, alkylthio group substituted by at least two halogen atoms, aryl group substituted by another electron-withdrawing group with a σp value of 0.20 or more, heterocyclic group, chlorine atom, bromine atom azo group, and selenocyanate group. Of these substituents, those capable of further having substituents can further have substitutes to be mentioned later for R₁₃.

In the specification, the aliphatic portion of the aliphatic oxycarbonyl group may be linear or branched, or cyclic and may be saturated or may contain an unsaturated bond. This aliphatic oxycarbonyl group includes, e.g., alkoxycarbonyl, cycloalkoxycarbonyl, alkenyloxycarbonyl, alkinyloxycarbonyl, and cycloalkenyloxycarbonyl.

The σp values of representative electron-withdrawing groups having a σp value of 0.2 to 1.0 are a bromine atom (0.23), chlorine atom (0.23), cyano group (0.66), nitro group (0.78), trifluoromethyl group (0.54), tribromomethyl group (0.29), trichloromethyl group (0.33), carboxyl group (0.45), acetyl group (0.50), benzoyl group (0.43), acetyloxy group (0.31), trifluoromethanesulfonyl group (0.92), methanesulfonyl group (0.72), benzenesulfonyl group (0.70), methanesulfinyl group (0.49), carbamoyl group (0.36), methoxycarbonyl group (0.45), ethoxycarbonyl group (0.45), phenoxycarbonyl group (0.44), pyrazolyl group (0.37), methanesulfonyloxy group (0.36), dimethoxyphosphoryl group (0.60), and sulfamoyl group (0.57). Each of the numbers in parenthesis is σp value.

R₁₁ preferably represents a cyano group, aliphatic oxycarbonyl group (a 2- to 36-carbon, linear or branched alkoxycarbonyl group, aralkyloxycarbonyl group, alkenyloxycarbonyl group, or alkinyloxycarbonyl group, or a 3-to 36-carbon cycloalkoxycarbbnyl group, or cycloalkenyloxycarbonyl group, e.g., methoxycarbonyl, ethoxycarbonyl, dodecyloxycarbonyl, octadecyloxycarbonyl, 2-ethylhexyloxycarbonyl, sec-butyloxycarbonyl, oleyloxycarbonyl, benzyloxycarbonyl, propargyloxycarbonyl, cyclopentyloxycarbonyl, cyclohexyloxycarbonyl, or 2,6-di-t-butyl-4-methylcylohexyloxycarbonyl); dialkylphosphono group (a 2- to 36-carbon dialkylphosphono group, e.g., diethylphosphono or dimethylphosphono); alkylsulfonyl or arylsulfonyl group (a 1- to 36-carbon alkylsulfonyl or 6- to 36-carbon arylsulfonyl group, e.g., a methanesulfonyl, butanesulfonyl, benzenesulfonyl, or p-toluenesulfonyl); or fluorinated alkyl group (a 1- to 36-carbon fluorinated alkyl group, e.g., trifluoromethyl). R₁₁ is particularly preferably a cyano group, aliphatic oxycarbonyl group, or fluorinated alkyl group, and most preferably, a cyano group.

R₁₂ preferably represents an aliphatic oxycarbonyl group as mentioned above for R₁₁; carbamoyl group (a 1- to 36-carbon carbamoyl group, e.g., diphenylcarbamoyl or dioctylcarbamoyl); sulfamoyl group (a 1- to 36-carbon sulfamoyl, e.g., dimethylsulfamoyl or dibutylsulfamoyl); dialkylphosphono group mentioned above for R₁₁; diarylphosphono group (a 12- to 50-carbon diarylphosphono group, e.g., diphenylphosphono or di(p-tolyl)phosphono). R₁₂ is particularly preferably an aliphatic oxycarbonyl group or heterocyclic oxycarbonyl group represented by the following formula (Z):

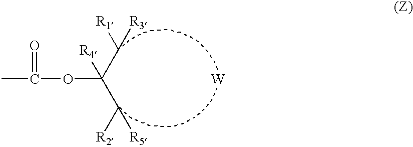

wherein each of R₁′ and R₂′ represents an aliphatic group, e.g., a 1- to 36-carbon, linear or branched alkyl group, 7- to 36-carbon aralkyl group, a 2- to 36-carbon alkenyl group, 2- to 36-carbon alkinyl group, 3- to 36-carbon cycloalkyl group, or 3- to 36-carbon cycloalkenyl group, and more specifically, methyl, ethyl, propyl, isopropyl, t-butyl, t-amyl, t-octyl, tridecyl, cyclopentyl, cyclohexyl, isopropenyl, 2-penenyl or 2-butynyl. Each of R₃′, R₄′, and R₅′ represents a hydrogen atom or aliphatic group. Examples of the aliphatic group are those mentioned above for R₁′ and R₂′. Each of R₃′, R₄′, and R₅′ is preferably a hydrogen atom.

W represents a non-metallic atomic group required to form a 5- to 8-membered ring. This ring may be substituted, may be a saturated ring, or can have an unsaturated bond. The non-metallic atom is preferably a nitrogen atom, oxygen atom, sulfur atom, or carbon atom, and more preferably, a carbon atom.

Examples of a ring formed by W are a cyclopentane ring, cyclohexane ring, cycloheptane ring, cyclooctane ring, cyclohexene ring, piperazine ring, oxane ring, and thiane ring. These rings can be substituted by the substituents represented by R₁₃ to be described later.

A ring formed by W is preferably a cyclohexane ring which may be substituted, and especially preferably, a cyclohexane ring whose 4-position is substituted by a 1- to 36-carbon alkyl group (which may be further substituted by a substituent represented by R₁₃ to be described later).

R₁₃ represents a substituent. R₁₃ will be described in detail below.

The substituent represented by R₁₃ includes a halogen atom, aliphatic group, aryl group, heterocyclic group, cyano group, hydroxyl group, nitro group, carboxyl group, amino group, alkoxy group, aryloxy group, acylamino group, alkylamino group, anilino group, ureido group, sulfamoylamono group, alkylthio group, arylthio group, alkoxycarbonylamino group, sulfonamide group carbamoyl group, sulfamoyl group, sulfonyl group, alkoxycarbonyl group, heterocyclic oxy group, azo group, acyloxy group, carbamoyloxy group, silyloxy group, aryloxycarbonylamino group, imide group, heterocyclicthio group, sulfinyl group, phosphonyl group, aryloxycarbonyl group, acyl group, and azolyl group. R₁₃ may be a divalent group thereby to form a bis coupler.

More specifically, examples of R₁₃ include a hydrogen atom, halogen atom (e.g., a chlorine atom and bromine atom); aliphatic group (e.g., a 1- to 80-carbon, linear or branched alkyl group, alkenyl group, alkynyl group, 3- to 80-carbon cycloalkyl group, or cycloalkenyl group, more specifically, methyl, ethyl, propyl, isopropyl, t-butyl, tridecyl, 2-methanesulfonylethyl, 3-(3-pentadecylphenoxy)propyl, 3-{4-12-[4-(4-hydroxyphenylsulfonyl)phenoxy]dodecanamid o}phenyl}propyl, 2-ethoxytridecyl, trifluoromethyl, cyclopentyl, 3-(2,4-di-t-amylphenoxy)propyl), isopropenyl, 2-pentenyl, and 2-butynyl); aryl group (e.g., phenyl, 4-t-butylphenyl, 2,4-di-t-amylphenyl, and 4-tetradecanamidophenyl); heterocyclic group (e.g., 2-furyl, 2-thienyl, 2-pyrimidinyl, and 2-benzothiazolyl); cyano group; hydroxyl group; nitro group; carboxyl group; amino group; alkoxy group (e.g., methoxy, ethoxy, 2-methoxyethoxy, 2-dodecylethoxy, and 2-methanesulfonylethoxy); aryloxy group (e.g., phenoxy, 2-methylphenoxy, 4-t-butylphenoxy, 3-nitrophenoxy, 3-t-butyloxycarbamoylphenoxy, and 3-methoxycarbamoylphenoxy); acylamino group (e.g., acetamide, benzamide, tetradecanamide, 2-(2,4-di-t-amylphenoxy)butaneamide, 4-(3-t-butyl-4-hydroxyphenoxy)butanamide, 2-{4-(4-hydroxyphenylsulfonyl)phenoxy}decanamide); alkylamino group (e.g., methylamino, butylamino, dodecylamino, diethylamino, and methylbutylamino); anilino group (e.g., phenylamino, 2-chloroanilino, 2-chloro-5-tetradecanaminoanilino, 2-chloro-5-dodecyloxycarbonylanilino, N-acetylanilino, and 2-chloro-5-{α-(3-t-butyl-4-hydroxyphenoxy) dodecanamido}anilino); ureido group (e.g., phenylureido, methylureido, and N,N-dibutylureido); sulfamoylamino group (e.g., N,N-dipropylsulfamoylamino and N-methyl-N-decylsulfamoylamino); alkylthio group (e.g., methylthio, octylthio, tetradecylthio, 2-phenoxyethylthio, 3-phenoxypropylthio, and 3-(4-t-butylphenoxy)propylthio); arylthio group (e.g., phenylthio, 2-butoxy-5-t-octylphenylthio, 3-pentadecylphenylthio, 2-carboxyphenylthio, and 4-tetradecanamidophenylthio); alkoxycarbonylamino group (e.g., methoxycarbonylamino and tetradecyloxycarbonylamino); sulfonamide group (e.g., methanesulfonamide, hexadecanesulfonamide, benzenesulfonamide, p-toluenesulfonamide, octadecanesulfonamide, and 2-methyloxy-5-t-butylbenzenesulfonamide); carbamoyl group (e.g., N-ethylcarbamoyl, N,N-dibutylcarbamoyl, N-(2-dodecyloxyethyl)carbamoyl, N-methyl-N-dodecylcarbamoyl, and N-(3-(2,4-di-t-amylphenoxy)propyl)carbamoyl); sulfamoyl group (e.g., N-ethylsulfamoyl, N,N-dipropylsulfamoyl, N-(2-dodecyloxyethyl)sulfamoyl, N-ethyl-N-dodecylsulfamoyl, and N,N-diethylsulfamoyl); sulfonyl group (e.g., methanesulfonyl, octanesulfonyl, benzenesulfonyl, and toluenesulfonyl); alkoxycarbonyl group (e.g., methoxycarbonyl, butyloxycarbonyl, dodecyloxycarbonyl, and octadecyloxycarbonyl); heterocyclic oxy group (e.g., 1-phenyltetrazole-5-oxy and 2-tetrahydropyranyloxy); azo group (e.g., phenylazo, 4-methoxphenylazo, 4-pyvaloylaminophenylazo, and 2-hydroxy-4-propanoylphenylazo); acyloxy group (e.g., acetoxy); carbamoyloxy group (e.g., N-methylcarbamoyloxy and N-phenylcarbamoyloxy); silyloxy group (e.g., trimethylsilyloxy and dibutylmethylsilyloxy); aryloxycarbonylamino group (e.g., phenoxycarbonylamino); imide group (e.g., N-succinimide, N-phthalimide, and 3-octadecenylsuccinimide); heterocyclic thio group (e.g., 2-benzothiazolylthio, 2,4-di-phenoxy-1,3,5-trizole-6-thio, and 2-pyridylthio); sulfinyl group (e.g., dodecanesulfinyl, 3-pentadecylphenylsulfinyl, and 3-phenoxypropylsulfinyl); phosphonyl group (e.g., phenoxyphosphonyl, octyloxyphosphonyl, and phenylphosphonyl); aryloxycarbonyl group (e.g., phenoxycarbonyl); acyl group (e.g., acetyl, 3-phenylpropanoyl, benzoyl, and 4-dodecyloxybenzoyl); and azolyl group (e.g., imidazolyl, pyrazolyl, 3-chloro-pyrazole-1-yl, and triazole).

Of these substituents, those capable of having a further substituent may have an organic substituent that is bonded to R₁₃ via a carbon atom, oxygen atom, nitrogen atom or sulfur atom, or a halogen atom.

Of these substituents, preferable examples of R₁₃ include an alkyl group, aryl group, alkoxy group, aryloxy group, alkylthio group, ureido group, alkoxycarbonylamino group, an aryloxycarbonylamino group and an acylamino group.

The coupler represented by general formula (CC-1) may be in the form of a dimer or more polymeric compound in which the group of R₁₂ or R₁₃ contains a residual group formed from the coupler represented by general formula (CC-1), or may be in the form of a homopolymer or copolymer in which the group of R₁₂ or R₁₃ contains a macromolecular chain. Typical examples of the homopolymer or copolymer containing a macromolecular chain are homo- or co-polymers of addition polymerized ethylenic, unsaturated compounds having a residual group formed from the coupler represented by general formula (CC-1). At least one cyan dye-forming repeating unit having a residual group formed from the coupler represented by general formula (CC-1) may be contained in these polymers. Further, the copolymer may contain as a copolymer ingredient, one or more kinds of non-coloring ethylenic monomer which does not couple with the oxidation product of an aromatic primary amine developing agent such as acrylic acid esters, methacrylic acid esters and maleic acid esters. The polymerization degree is preferably from 100 to 1000.

Of the cyan couplers represented by general formula (CC-1), preferred are those represented by general formula (CC-2) below.

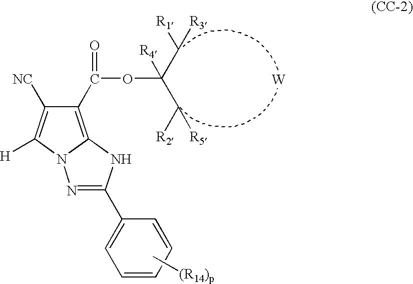

In general formula (CC-2), R₁₄ represents a substituent other than a hydrogen atom. p represents a natural number of from 1 to 5. If p is 2 or greater, all of the R₁₄'s may be the same or different. R₁′, R₂′, R₃′, R₄′ and R₅′ have the same meanings as those defined for general formula (Z) described in the explanation of R₁₂ in general formula (CC-1).

General formula (CC-2) is described below. With respect to the substituent represented by R₁₄, examples thereof include those mentioned for R₁₃ of general formula (CC-1). Preferred examples include a chlorine atom, a fluorine atom, an alkyl group, an alkoxy group, an amino group, an alkylthio group, an arylthio group, an aryloxy group, an acylamino group, a sulfonylamino group, a carbamoyl group, a sulfamoyl group, a carbonyloxy group, an oxycarbonyl group, an ureido group, an oxycarbonylamino group, an aminocarbonyloxy group, a carboxyl group, and a cyano group. It is preferable that at least one R₁₄ is a substituent having 6 to 80 carbon atoms, especially an alkyl, alkoxy, acylamino, sulfonylamino, carbamoyl, sulfamoyl, carbonyloxy, oxycarbonyl, aminocarbonylamino, oxycarbonylamino or aminocarbonyloxy group having 6 to 80, more preferably from 10 to 60, carbon atoms, if p is 2 or greater. Further, if R₁₄ is a group having 6 to 80 carbon atoms, the substitution position of R₁₄ on the phenyl group in general formula (CC-2) is preferably the meta or para position to a pyrrolotriazole moiety, and more preferably, the meta position.

The most preferable couplers represented by general formula (CC-2) include those in which R₁′ and R₂′ each are a tertiary alkyl group, R₃′, R₄′ and R₅′ each are a hydrogen atom, a ring formed of W is a cyclohexane ring, p is 2 or greater, and at least one R₁₄ is a group selected from the group consisting of an alkoxy group, a acylamino group, a sulfonylamino group, a carbamoyl group, a sulfamoyl group, a carbonyloxy group, an oxycarbonyl group, an aminocarbonylamino group, an oxycarbonylamino group and an aminocarbonyloxy group having 10 to 60 carbon atoms. Among them, preferred is a coupler in which R₁₄ is located at the meta position on the phenyl group to a pyrrolotriazole moiety and an amino group to which an alkoxy, aryloxy or alkyl group is substituted is located at the para position to the pyrrolotriazole on the phenyl group. The most preferable substituent as that located at the para position is an amino group to which a cyclic alkyl group having 3 to 30 carbon atoms or linear alkyl group having 2 to 30 carbon atoms is substituted.

The following are specific examples of the coupler of general formula (CC-1), but the present invention is not limited to them.

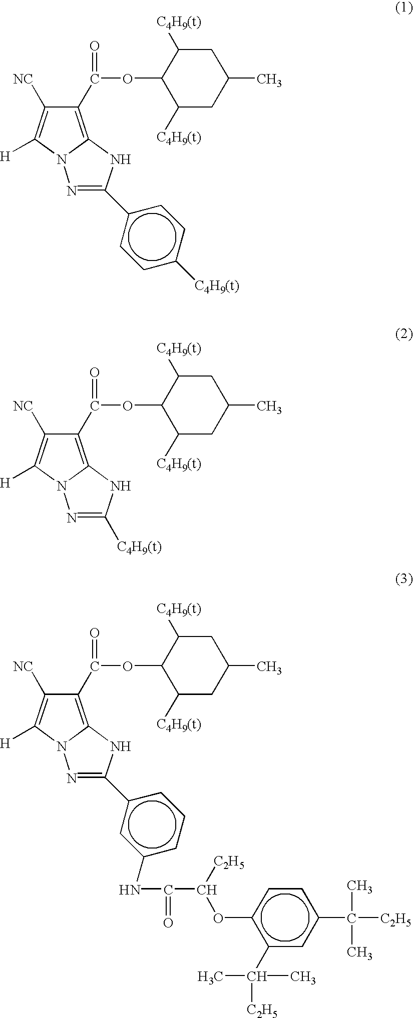

The compounds represented by general formula (CC-1) of the present invention can be prepared by known methods, such as those disclosed in, for example, J. C. S., 1961, p.518, J. C. S., 1962, p.5149, Angew. Chem., Vol.72, p.956 (1960), Berichte, Vol.97, p.3436 (1964), U.S. Pat. No. 5,256,526, European Patent No. 545,300 and documents cited in these publications and similar methods.

Next, the compound represented by general formula (SC-I) is described below.

In general formula (SC-I), Y represents a carbonyl group or a sulfonyl group.

The non-metallic atomic group capable of forming a 5- or 6-membered ring represented by Q₁ in general formula (SC-I) is described in detail below. Q₁ may be any non-metallic atom, but is preferably selected from a group consisting of a carbon atom, nitrogen atom, oxygen atom and sulfur atom, and more preferably is selected from a group consisting of a carbon atom and oxygen atom. The number of the members contained in a ring which is formed by Q₁ together with —CO—C (Y) H—X— is 5 or 6. The atoms forming this ring may substituted with a substituent selected from an aliphatic group, alkoxy group, alkoxycarbonyl group, carbamoyl group, carbonamide group, sulfonamide group and sulfamoyl group. An atom forming the ring may be a carbonyl group, sulfonyl group or sulfinyl group. The ring may contain a multiple bond. Further, this ring may be fused with another ring, which may be further substituted with a substituent selected from an aliphatic group, alkoxy group, alkoxycarbonyl group and carbamoyl group.

The number of the members of the ring to be formed by Q₁ together with —CO—C (Y) H—X— is preferably 5. Specifically, preferred is a case in which —O—C— or —C—C— is arranged from the nearest side of the carbonyl group. At this time, the carbon atom(s) corresponding to Q₁ may be unsubstituted or may be substituted with a substituent selected from an aliphatic group, alkoxy group, alkoxycarbonyl group and carbamoyl group. More preferable case of the carbon atom(s) corresponding to Q₁ is unsubstituted.

The non-metallic atomic group capable of forming a 5- or 6-membered ring represented by Q₂ in general formula (SC-I) is described in detail below. Q₂ may be any non-metallic atom, but is preferably selected from a group consisting of a carbon atom, nitrogen atom, oxygen atom and sulfur atom, and more preferably is selected from a group consisting of a carbon atom and oxygen atom. The number of the members contained in a ring which is formed by Q₂ together with —X—CH(CO—) —Y—is 5 or 6. The atoms forming this ring may substituted with a substituent selected from an aliphatic group, alkoxy group, alkoxycarbonyl group, carbamoyl group, carbonamide group, sulfonamide group and sulfamoyl group. An atom forming the ring may be a carbonyl group, sulfonyl group or sulfinyl group. The ring may contain a multiple bond. Further, this ring may be fused with another ring, which may be substituted with a substituent selected from an aliphatic group, alkoxy group, alkoxycarbonyl group and carbamoyl group.

The number of the members of the ring to be formed by Q₂ together with —X—CH (CO—) —Y— is preferably 6. Specifically, preferred is a case in which —C—C—C— is arranged from the nearest side of X. At this time, the carbon atoms corresponding to Q₂ may be unsubstituted or may be substituted with a substituent selected from an aliphatic group, an alkoxy group, an alkoxycarbonyl group and a carbamoyl group. More preferable case is that at least one of the carbon atoms is unsubstituted or substituted with an aliphatic group.

C—Rₓ or an N atom represented by X in general formula (SC-I) is described in detail below. Rₓ represents a hydrogen atom or a substituent examples of which include an aliphatic group, an alkoxy group, an alkoxycarbonyl group and a carbamoyl group. The case of C—H is the most preferable as X.

Next, specific examples of the compound represented by general formula (SC-I) are shown below, but the present invention is not limited to these specific examples.

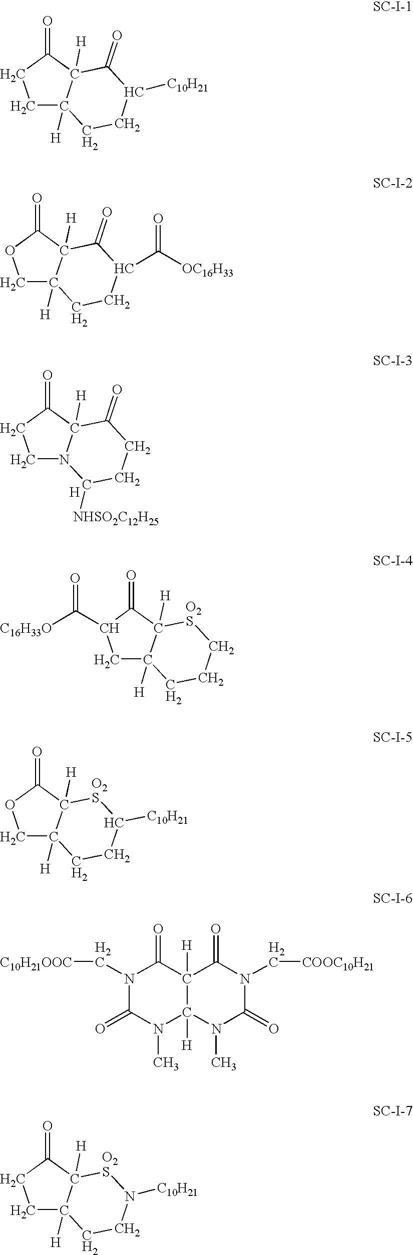

Next, the compound represented by general formula (SC-II) is described below.

The non-metallic atomic group capable of forming a 5- or 6-membered ring represented by Q₃ in general formula (SC-II) is described in detail below. Q₃ may be any non-metallic atom, but is preferably selected from a group consisting of a carbon atom, nitrogen atom, oxygen atom and sulfur atom, and more preferably is selected from a carbon atom and oxygen atom. The number of the members contained in a ring which is formed by Q₃ together with —CO—C(R₁) H— is 5 or 6. The atoms forming this ring may substituted with a substituent selected from an aliphatic group, an alkoxy group, an alkoxycarbonyl group, a carbamoyl group, a carbonamide group, a sulfonamide group and a sulfamoyl group. An atom forming the ring may be a carbonyl group, a sulfonyl group or a sulfinyl group. The ring may contain a multiple bond. Further, this ring may be fused with another ring, which may be substituted with a substituent selected from an aliphatic group, an alkoxy group, an alkoxycarbonyl group and a carbamoyl group.

The number of the members of the ring to be formed by Q₃ together with —CO—C(R₁) H— is preferably 5. Specifically, preferred is a case in which —O—C—C— or —C—C—C— is arranged from the nearest side of the carbonyl group. At this time, the carbon atoms corresponding to Q₃ may be unsubstituted or may be substituted with a substituent selected from an aliphatic group, an alkoxy group, an alkoxycarbonyl group and a carbamoyl group and also may be fused with another ring. More preferable case is that a benzene ring is fused to the carbon atoms or that the carbon atoms are unsubstituted.

The substituted or unsubstituted aryl group or substituted carbonyl group represented by R₁ in general formula (SC-II) is described in detail below. Examples of substituents in the substituted aryl group or a substituted carbonyl group represented by R₁ include various substituents such as those mentioned for R₁₃ described above. Particularly preferable substituents include a halogen atom, an aliphatic group, an aryl group, a hydroxyl group, a carboxyl group, an alkoxy group, an aryloxy group, an acylamino group, an alkylamino group, an anilino group, a sulfonamide group, a carbamoyl group, a sulfamoyl group, a sulfonyl group and an alkoxycarbonyl group. Among these substituents, those capable of being substituted may be further substituted with a substituent such as those mentioned for R₁₃.

More preferable examples of the substituent of the substituted aryl group represented by R₁ include a hydrogen atom, halogen atom, aliphatic group (for example, a liner or branched alkyl group having 1 to 80 carbon atoms, aralkyl group having 7 to 36 carbon atoms, alkenyl group having 2 to 36 carbon atoms, alkinyl group having 2 to 36 carbon atoms, cycloalkyl group having 3 to 36 carbon atoms, and cycloalkenyl group having 3 to 36 carbon atoms), a hydroxyl group and an alkoxycarbonyl group having 2 to 36 carbon atoms.

More preferable examples of the substituent of the substituted carbonyl group represented by R₁ include a substituted or unsubstituted anilino group, an alkoxy group and an aryloxy group.

Next, specific examples of the compound represented by general formula (SC-II) are shown below, but the present invention is not limited to these specific examples.

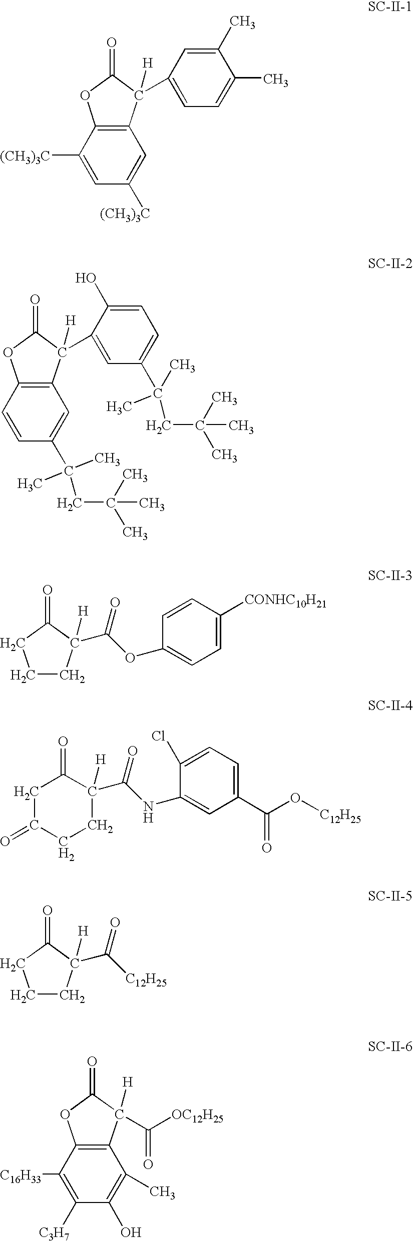

Next, the compound represented by general formula (SC-III) is described below.

The non-metallic atomic group capable of forming a 5- or 6-membered ring represented by Q₄ in general formula (SC-III) is described in detail below. Q₄ may be any non-metallic atom, but is preferably selected from a group consisting of a carbon atom, nitrogen atom, oxygen atom and sulfur atom, and more preferably is selected from a group consisting of a carbon atom, nitrogen atom and oxygen atom. The number of the members contained in a ring which is formed by Q₄ together with the pyrrole ring is 5 or 6. The atoms forming this ring may be substituted with a substituent such as those mentioned for R₁₃ previously. If such a substituent can be further substituted, it may be substituted with a substituent such as those mentioned for R₁₃ previously.

The number of the members contained in a ring which is formed by Q₄ together with the pyrrole ring is preferably 5. Specifically, preferred is that in which —N═C(R₄₁)—NH— or —C(R₄₁)═N—NH— is arranged from the side of the N atom of the pyrrole. At this time, R₄₁ represents a substituent. The substituent R₄₁ is preferably a substituted or unsubstituted aryl group or a substituted or unsubstituted aliphatic group.

The substituents represented by R₂ and R₃ in general formula (SC-III) are described in detail below. Although substituents such as those mentioned for R₁₃ previously can be mentioned as the substituents represented by R₂ and R₃, particularly preferred are electron-withdrawing groups having a Hammett substituent constant σp of from 0.20 to 1.0.

R₂ preferably represents a cyano group, aliphatic oxycarbonyl group (an linear or branched alkoxycarbonyl group having 2 to 36 carbon atoms, aralkyloxycarbonyl group having 7 to 36 carbon atoms, alkenyloxycarbonyl group having 3 to 36 carbon atoms, alkinyloxycarbonyl group having 3 to 36 carbon atoms, cycloalkoxycarbonyl group having 4 to 36 carbon atoms, and cycloalkenyloxycarbonyl group having 4 to 36 carbon atoms; e.g., methoxycarbonyl, ethoxycarbonyl, dodecyloxycarbonyl, octadecyloxycarbonyl, 2-ethylhexyloxycarbonyl, sec-butyloxycarbonyl, oleyloxycarbonyl, benzyloxycarbonyl, propargyloxycarbonyl, cyclopentyloxycarbonyl, cyclohexyloxycarbonyl, 2,6-di-tert-butyl-4-methylcyclohexyloxycarbonyl, isopropenyl, 2-pentenyl, and 2-butynyl), a dialkylphosphono group (a dialkylphosphono group having 2 to 36 carbon atoms; e.g., diethylphosphono and dimethylphosphono), an alkylsulfonyl or arylsulfonyl group (an alkylsulfonyl group having 1 to 36 carbon atoms and an arylsulfonyl group having 6 to 36 carbon atoms; e.g., a methanesulfonyl, butanesulfonyl, benzenesulfonyl and a p-toluenesulfonyl), and a fluorinated alkyl group (a fluorinated alkyl group having 1 to 36 carbon atoms; e.g., trifluoromethyl). Particularly preferred as R₂ are a cyano group, aliphatic oxycarbonyl group and fluorinated alkyl group. A cyano group is most preferable.

Preferable examples of R₃ include aliphatic oxycarbonyl groups such as those mentioned for R₂, carbamoyl group (a carbamoyl group having 1 to 36 carbon atoms; e.g., diphenylcarbamoyl and dioctylcarbamoyl), a sulfamoyl group (a sulfamoyl group having 1 to 36 carbon atoms; e.g., dimethylsulfamoyl and dibutylsulfamoyl), dialkylphosphono groups such as those mentioned for R₂, and diarylphosphono group (a diarylphosphono group having 12 to 50 carbon atoms; e.g., diphenylphosphono and di(p-toluyl)phosphono). Particularly preferred as R₃ are an aliphatic oxycarbonyl group and heterocyclic oxycarbonyl group.

Next, the group represented by L₁ in general formula (SC-III) is described in detail below. L₁ represents a group that does not leave in its reaction with an aromatic primary amine color developing agent. Preferable examples of L₁ include a substituted or unsubstituted aliphatic group, a substituted or unsubstituted aryl group, an acylamino group, an alkoxycarbonylamino group, an aryloxycarbonyl group, an ureido group and a substituted or unsubstituted heterocyclic group (pyrazole, imidazole and pyrrole). Particularly preferred is an unsubstituted aliphatic group.

Next, specific examples of the compound represented by general formula (SC-III) are shown below, but the present invention is not limited to these specific examples.

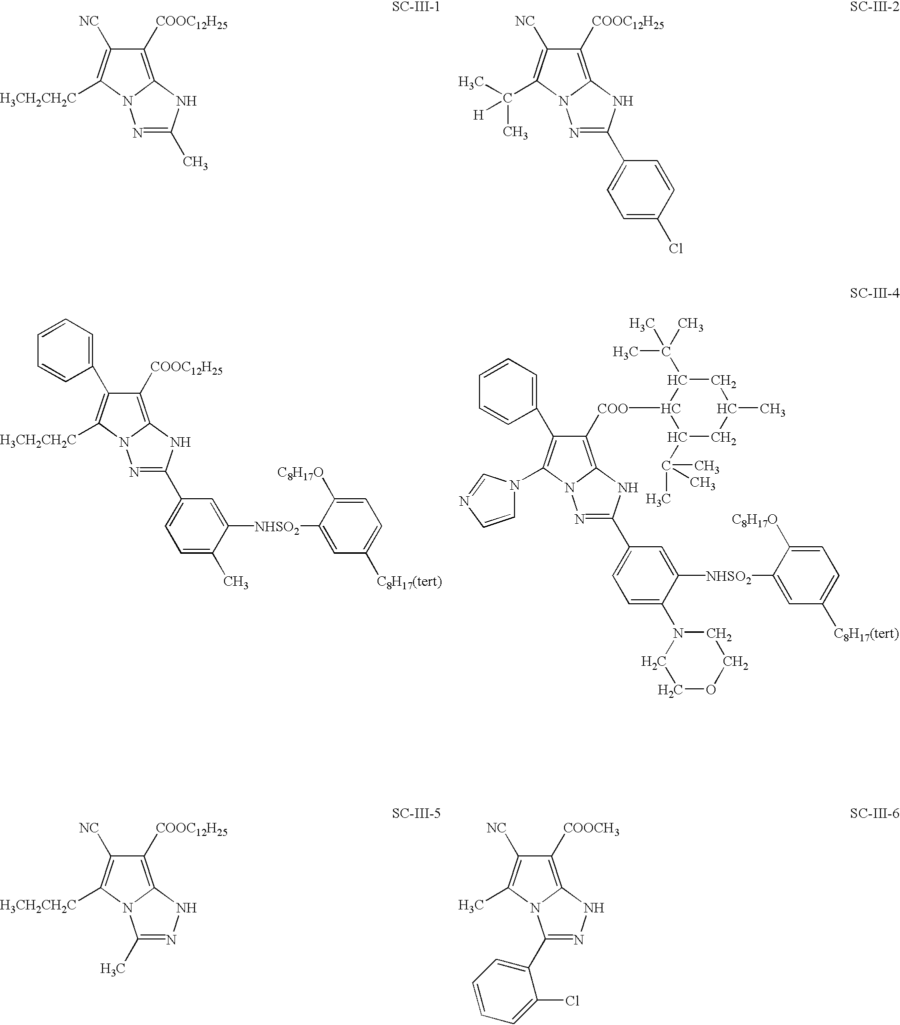

Next, the compound represented by general formula (SC-IV) is described below.

The non-metallic atomic group capable of forming a 5- or 6-membered ring represented by Q₅ in general formula (SC-IV) is described in detail. Q₅ may be any non-metallic atom, but is preferably selected from a group consisting of a carbon atom, nitrogen atom, oxygen atom and sulfur atom, and more preferably is selected from a group consisting of a carbon atom, nitrogen atom and oxygen atom. The number of the members contained in a ring which is formed by Q₅ together with the pyrazole ring is 5 or 6. The atoms forming this ring may substituted with a substituent such as those mentioned for R₁₃ previously. If such a substituent can be further substituted, it may be substituted with a substituent such as those mentioned for R₁₃ previously.

The number of the members contained in the ring which is formed by Q₅ together with a pyrazole ring is preferably 5. Specifically, preferred is that in which —N═C(R₅₁)—NH— or —C(R₅₁)═N—NH— is arranged from the side of the N atom of the pyrazole. Wherein R₅₁ represents a substituent. The substituent R₅₁ is preferably a substituted or unsubstituted aryl group or substituted or unsubstituted aliphatic group.

The substituent represented by R₄ in general formula (SC-IV) is described in detail below. Although substituents such as those mentioned for R₁₃ previously can be mentioned as the substituents represented by R₄, preferred are an aliphatic group and alkoxy group, and particularly preferred is an aliphatic group.

Next, the group represented by L₂ in general formula (SC-IV) is described in detail below. L₂ represents a group that does not leave in its reaction with an aromatic primary amine color developing agent. Preferable examples of L₂ include a substituted or unsubstituted aliphatic group and substituted or unsubstituted aryl group. Particularly preferred is an unsubstituted aliphatic group.

Next, specific examples of the compound represented by general formula (SC-IV) are shown below, but the present invention is not limited to these specific examples.

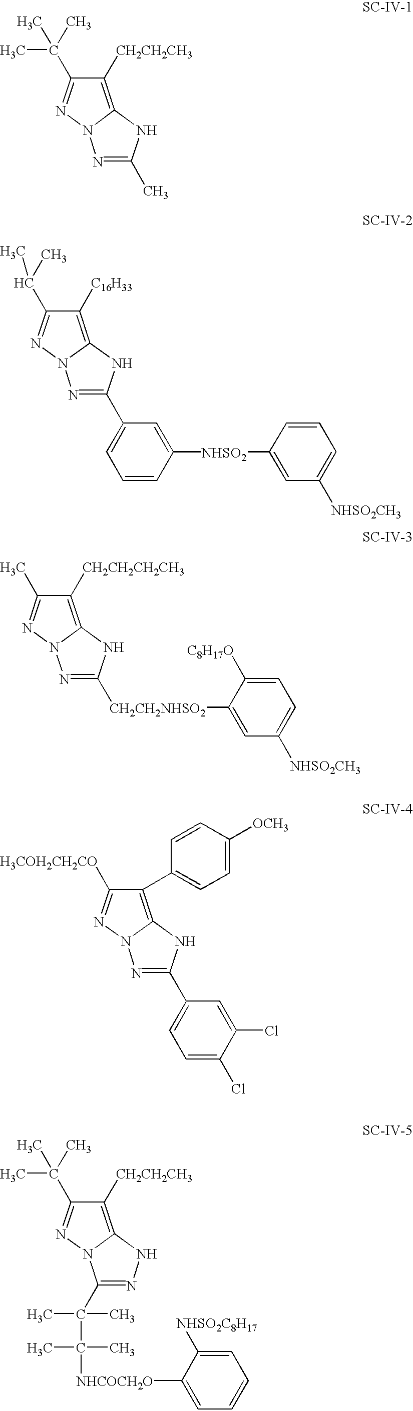

Next, the compound represented by general formula (SC-V) is described below.

The substituent represented by R₅ and R₆ in general formula (SC-V) is described in detail below. Although substituents such as those mentioned for R₁₃ previously can be mentioned as the substituents represented by R₅ and R₆, particularly preferred are a substituted or unsubstituted aliphatic group, substituted or unsubstituted alkoxy group, or substituted or unsubstituted aryl group.

Next, the group represented by L₃ in general formula (SC-V) is described in detail below. L₃ represents a group that does not leave in its reaction with an aromatic primary amine color developing agent. Preferable examples of L₃ include a substituted or unsubstituted aliphatic group and substituted or unsubstituted aryl group. Particularly preferred is an unsubstituted aliphatic group.

Next, specific examples of the compound represented by general formula (SC-V) are shown below, but the present invention is not limited to these specific examples.

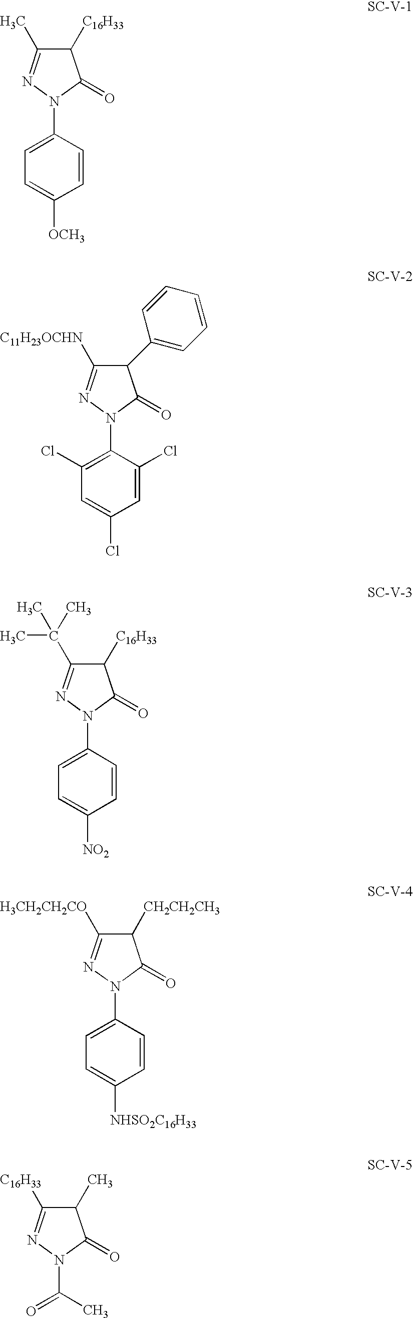

The compounds represented by general formulas (SC-I) to (SC-V) of the present invention can be synthesized using various known synthesis methods. As references can be cited Synth. Commun., 551-558 (1980), Chem. Lett., 339-340 (1985), Liebigs Ann. Chem., 112-136 (1983), Chem. Ber., 2702-2707 (1961), Tetrahedron, 6085-6116 (1996), Tetrahedron Lett., 2201-2204 (1984), and J. Org. Chem., 1216-1224 (1985).

The coupler represented by general formula (CC-1) of the present invention and the compounds represented by general formulas (SC-I), (SC-II), (SC-III), (SC-IV) and (SC-V) of the present invention can be introduced into a material using various known dispersion methods. Preferred is an oil-in-water dispersion method in which a compound is dissolved in a high-boiling organic solvent (if necessary, together with a low-boiling organic solvent), and the resultant solution is emulsified and dispersed into an aqueous solution of gelatin, and then the thus-obtained emulsified dispersion is added to a silver halide emulsion.

Examples of the high-boiling solvent used in this oil-in-water dispersion method are described in, e.g., U.S. Pat. No. 2,322,027. Practical examples of steps, effects, and impregnating latexes of a latex dispersion method as one polymer dispersion method are described in, e.g., U.S. Pat. No. 4,199,363, West German Patent Application (OLS) Nos. 2,541,274 and 2,541,230, JP-B-53-41091, and EPO₂₉₁₀₄. Dispersion using an organic solvent-soluble polymer is described in PCT International Publication WO88/00723.

Examples of the high-boiling solvent usable in the abovementioned oil-in-water dispersion method are phthalic acid esters (e.g., dibutyl phthalate, dioctyl phthalate, dicyclohexyl phthalate, di-2-ethylhexyl phthalate, decyl phthalate, bis(2,4-di-tert-amylphenyl)isophthalate, and bis(1,1-diethylpropyl)phthalate), esters of phosphoric acid and phosphonic acid (e.g., diphenyl phosphate, triphenyl phosphate, tricresyl phosphate, 2-ethylhexyldiphenyl phosphate, dioctylbutyl phosphate, tricyclohexyl phosphate, tri-2-ethylhexyl phosphate, tridodecyl phosphate, and di-2-ethylhexylphenyl phosphate), benzoic acid esters (e.g., 2-ethylhexyl benzoate, 2,4-dichloro benzoate, dodecyl benzoate, and 2-ethylhexyl-p-hydroxy benzoate), amides (e.g., N,N-diethyldodecanamide and N,N-diethyllaurylamide), alcohols and phenols (e.g., isostearylalcohol and 2,4-di-tert-amylphenol), aliphatic esters (e.g., dibutoxyethyl succinate, di-2-ethylhexyl succinate, 2-hexyldecyl tetradecanate, tributyl citrate, diethylazelate, isostearyl lactate, and trioctyl tosylate), aniline derivatives (e.g., N,N-dibutyl-2-butoxy-5-tert-octylaniline), chlorinated paraffins (paraffins containing 10% to 80% of chlorine), trimesic acid esters (e.g., tributyl trimesate), dodecylbenzene, diisopropylnaphthalene, phenols (e.g., 2,4-di-tert-amylphenol, 4-dodecyloxyphenol, 4-dodecyloxycarbonylphenol, and 4-(4-dodecyloxyphenylsulfonyl)phenol), carboxylic acids (e.g., 2-(2,4-di-tert-amylphenoxybutyric acid and 2-ethoxyoctanedecanic acid), alkylphosphoric acids (e.g., di-(2-ethylhexyl)phosphoric acid and diphenylphosphoric acid). In addition to the above high-boiling solvents, compounds described in, e.g., JP-A-6-258803 can also be preferably used as high-boiling solvents.

The amount of such a high-boiling organic solvent is preferably from 0 to 1.0, more preferably from 0 to 0.5 in weight ratio in its use for a coupler of the present invention, and is preferably from 0 to 5.0, more preferably from 0 to 3.0 in weight ratio in the case of its use for other additives of the present invention.

Further, organic solvents having a boiling point of from 30° C. to approximately 160° C. (for example, ethyl acetate, butyl acetate, ethyl propionate, methyl ethyl ketone, cyclohexanone, 2-ethoxyethyl acetate and dimethylformamide) can be used in combination as an auxiliary solvent.

The content of the coupler represented by general formula (CC-1) of the present invention in the material is from 0.01 g to 10 g per m², preferably, from 0.1 g to 2 g per m². The coupler content is suitably from 1×10⁻³ mol to 1 mol, preferably, from 2×10⁻³ to 3×10⁻¹ mol per mol of silver halide contained in the same lightsensitive emulsion layer.

The layer to which the coupler represented by general formula (CC-1) of the present invention is added is preferably a red-sensitive emulsion layer, but the addition of the coupler to the other layers will cause no problems.

Further, if there is another color-sensitive emulsion layer closer to the support than the red-sensitive emulsion layer, the coupler may be added to the color-sensitive emulsion layer.

In the present invention, an embodiment in which a compound of general formula (SC-I) is used in combination with a coupler of general formula (CC-1) in the same layer is preferable. The addition amount of the compound is preferably within the range of from 0.001 mol to 0.2 mol, more preferably, from 0.01 mol to 0.1 mol per mol of the coupler of general formula (CC-1).

In the present invention, an embodiment in which a compound of general formula (SC-II) is used in combination with a coupler of general formula (CC-1) in the same layer is preferable. The addition amount of the compound. is preferably within the range of from 0.001 mol to 1.0 mol, more preferably, from 0.01 mol to 0.5 mol per mol of the coupler of general formula (CC-1).

In the present invention, an embodiment in which a compound of general formula (SC-III) is used in combination with a coupler of general formula (CC-1) in the same layer is preferable. The addition amount of the compound is preferably within the range of from 0.001 mol to 1.0 mol, more preferably, from 0.01 mol to 0.5 mol per mol of the coupler of general formula (CC-1).

In the present invention, an embodiment in which a compound of general formula (SC-IV) is used in combination with a coupler of general formula (CC-1) in the same layer is preferable. The addition amount of the compound is preferably within the range of from 0.001 mol to 1.0 mol, more preferably, from 0.01 mol to 0.5 mol per mol of the coupler of general formula (CC-1).

In the present invention, an embodiment in which a compound of general formula (SC-V) is used in combination with a coupler of general formula (CC-1) in the same layer is preferable. The addition amount of the compound is preferably within the range of from 0.001 mol to 1.0 mol, more preferably, from 0.01 mol to 0.5 mol per mol of the coupler of general formula (CC-1)

In the present invention, an embodiment in which two or more compounds selected from the compounds those of general formulas (SC-I) to (SC-V) are used in combination is also included. Further, an embodiment in which the coupler represented by general formula (CC-1) is used together with two or more of the compounds of general formulas (SC-I) to (SC-V) is also included. The addition amount of the compounds of general formulas (SC-I) to (SC-V), in total molar number of the compounds of general formulas (SC-I) to (SC-V) per mol of the coupler of general formula (CC-1), is preferably within the range of from 0.001 mol to 2.0 mol, more preferably, from 0.01 mol to 1.0 mol.

Among the compounds of general formulas (SC-I) to (SC-V) of the present invention, those of formulas (SC-II) and (SC-V) are especially preferred.

The light-sensitive material of the present invention need only have at least one lightsensitive emulsion layer, but preferably has at least one blue-sensitive silver halide emulsion layer, at least one green-sensitive silver halide emulsion layer, and at least one red-sensitive silver halide emulsion layer on a support. These layers are preferably formed by coating in this order from the one farthest from the support, but may be in the different order from this. In the present invention, a red-sensitive silver halide emulsion layer, a green-sensitive silver halide emulsion layer and a blue-sensitive silver halide emulsion layer are coated on the support in this order from the one closer to the support. Also, each color-sensitive layer preferably has a unit configuration including two or more lightsensitive emulsion layers differing in speed. In particular, a three-layered unit configuration including three lightsensitive emulsion layers, i.e., low-, medium-, and high-speed layers, in this order from the one closest to the support is favored. These are described in Jpn. Pat. Appln. KOKOKU Publication No. (hereinafter referred to as JP-B-) 49-14595, and JP-A-59-202464.

One preferred embodiment of the present invention is a photosensitive element in which a support is coated with layers in the order of an undercoat layer/antihalation layer/first interlayer/red-sensitive emulsion layer unit (including three layers in the order of a low-speed red-sensitive layer/medium-speed red-sensitive layer/high-speed red-sensitive layer from the one closest to the support)/second interlayer/green-sensitive emulsion layer unit (including three layers in the order of a low-speed green-sensitive layer/medium-speed green-sensitive layer/high-speed green-sensitive layer from the one closest to the support)/third interlayer/yellow filter layer/ blue-sensitive emulsion layer unit (including three layers in the order of a low-speed blue-sensitive layer/medium-speed blue-sensitive layer/high-speed blue-sensitive layer from the one closest to the support)/first protective layer/second protective layer.

Each of the first, second, and third interlayers can be a single layer or two or more layers. The first interlayer is preferably divided into two or more layers, and the layer directly adjacent to the red-sensitive layer preferably contains yellow colloidal silver. Likewise, the second interlayer preferably includes two or more layers, and the layer directly adjacent to the green-sensitive layer preferably contains yellow colloidal silver. In addition, a fourth interlayer is favorably formed between the yellow filter layer and the blue-sensitive emulsion layer unit.

The interlayers may contain a coupler, DIR compounds and the like such as those described in JP-A's-61-43748, 59-113438, 59-113440, 61-20037, and 61-20038. The interlayers may also contain a color-mixing-inhibiting agent, as usually do so.

Also, the protective layer preferably has a three-layered configuration including first to third protective layers. When the protective layer includes two or three layers, the second protective layer preferably contains a fine-grain silver halide having an average equivalent-sphere grain diameter of 0.10 μm or less. This silver halide is preferably silver bromide or silver iodobromide.

Since the object of the present invention is to solve problems when the photographic material is appreciated using a transmitted light, what is important for embodiments of the present invention is that a portion with the lowest density becomes a white background, and in such a case, the advantage of the present invention is shown. As for the density in a white background portion, all the yellow, magenta and cyan densities are preferably 0.3 or less, more preferably 0.2 or less.

The most typical embodiment of the present invention is color reversal film photographic materials having a white density of 0.2 or less.

A silver halide color photographic material of the present invention may have lightsensitive emulsion layers other than those described above. In particular, it is preferable, in view of color reproduction, to form a lightsensitive emulsion layer spectrally sensitized in a cyan light region to give an interlayer effect to the red-sensitive emulsion layer. The layer that gives an interlayer effect may be blue-sensitive, green-sensitive or red-sensitive. It is also possible to arrange a donor layer having an interlayer effect differing in spectral sensitivity distribution from those of the main lightsensitive layers BL, GL and RL as described in U.S. Pat. Nos. 4,663,271, 4,705,744, 4,707,436, JP-A's-62-160448 and 63-89850, adjacent to or close to the main lightsensitive layers.

The photographic material of the present invention contains an image-forming coupler. The image-forming coupler is a coupler capable of coupling with an aromatic primary amine color developing agent in an oxidized form to form an image-forming dye. Generally, yellow, magenta and cyan couplers are used together to form a color image.

The image-forming coupler of the present invention is preferably used by being added to a lightsensitive emulsion layer that is sensitive to a light in a complementary relationship with the coloring hue of the coupler. That is, a yellow coupler, a magenta coupler and a cyan coupler are added to a blue-sensitive emulsion layer, a green-sensitive emulsion layer, and a red-sensitive emulsion layer, respectively. Further, for the purpose of improving shadow description property and the like that the coupler that is not in relation of complementary color is used in combination, e.g., the cyan coupler or the yellow coupler is used together in the green-sensitive emulsion layer.

Preferable examples of the image-forming coupler to be used in the photographic material together with the coupler of the present invention include those shown below.

Yellow couplers: couplers represented by formulas (I) and (II) in EP No. 502,424A; couplers represented by formulas (1) and (2) in EP No. 513,496A (particularly Y-28 on page 18); a coupler represented by formula (I) in claim 1 of EP No. 568,037A; a coupler represented by general formula (I) in column 1, lines 45 to 55, in U.S. Pat. No. 5,066,576; a coupler represented by general formula (I) in paragraph 0008 of JP-A-4-274425; couplers described in claim 1 on page 40 in EP No. 498,381A1 (particularly D-35); couplers represented by formula (Y) on page 4 in EP No. 447,969A1 (particularly Y-1 and Y-54); and couplers represented by formulas (II) to (IV) in column 7, lines 36 to 58, in U.S. Pat. No. 4,476,219, the entire contents of which are incorporated herein by reference, and so on.

Magenta couplers: couplers described in JP-A-3-39737 (e.g., L-57, L-68, and L-77); couplers described in EP No. 456,257A (e.g., A-4-63, and A-4-73 and A-4-75); couplers described in EP No. 486,965A (e.g., M-4, M-6, and M-7; couplers described in EP No. 571,959A (e.g., M-45); couplers described in JP-A-5-204106 (e.g., M-1); and couplers described in JP-A-4-362631 (e.g., M-22), the entire contents of which are incorporated herein by reference, and so on.

Cyan couplers: couplers described in JP-A-4-204843 (e.g., CX-1, -3, -4, -5, -11, -12, -14, and -15); couplers described in JP-A-4-43345 (e.g., C-7, -10, -34 and -35, and (1-1) and (1-17)); couplers represented by general formulas (Ia) and (Ib) in claim 1 of JP-A-6-67385; couplers represented by general formula (PC-1) of JP-A-11-119393 (e.g., CB-1, CB-4, CB-5, CB-9, CB-34, CB-44, CB-49 and CB-51); couplers represented by general formula (NC-1) described in JP-A-11-11939 (e.g., CC-1 and CC-17), the entire contents of which are incorporated herein by reference, and so on.

These couplers may be introduced into a photographic material by various known dispersing methods in the similar manner as the couplers of the invention mentioned above.

The photographic material of the invention can also contain a competing compound (a compound which competes with an image forming coupler to react with a color developing agent in an oxidized form and which does not form any dye image). Examples of this competing coupler are reducing compounds such as hydroquinones, catechols, hydrazines, and sulfonamidophenols, and compounds which couple with a color developing agent in an oxidized form but do not substantially form a color image (e.g., non-dye-forming couplers disclosed in German Patent No. 1,155,675, British Patent No. 861,138, and U.S. Pat. Nos. 3,876,428 and 3,912,513, and couplers such as disclosed in JP-A-6-83002 by which generated dyes flow out during processing steps).

In the photographic material of the present invention, a lightsensitive unit having the same color-sensitivity may include a non-color-forming interlayer. The interlayer preferably contains a compound that is capable of being selected as the above-mentioned competing compounds.

To prevent deterioration of the photographic properties caused by formaldehyde gas, the photosensitive material of the present invention preferably contains compounds described in U.S. Pat. Nos. 4,411,987 and 4,435,503, which can react with and fix formaldehyde gas.

The photographic material of the invention may be subjected to any developing processing, but one of the objects of the present invention is the application of the photographic material to a color reversal film to which a black-and-white development is performed followed by reversal processing, and color development, which results in preferable advantages by the present invention.

In the invention, a precursor of formaldehyde means a compound providing formaldehyde in any stage of the development processing steps. Examples thereof include addition product of sodium bisulfite, addition product of formaldehyde and imidazole, and hexamethylenetetramine.

The general features of the color reversal processing steps applicable to the present invention will be described below.

Black-and-white development (first development) as the first step will be explained.

As a black-and-white developer, any conventionally known developing agent can be used. Examples of the developing agent are dihydroxybenzenes (e.g., hydroquinone and hydroquinone monosulfonate), 3-pyrazolidones (e.g., 1-phenyl-3-pyrazolidone and 1-phenyl-4-methyl-4-hydroxymethyl-3-pyrazolidone), aminophenols (e.g., N-methyl-p-aminophenol and N-methyl-3-methyl-p-aminophenol), and ascorbic acid and its isomer or derivative. These developing agents can be used singly or together. A preferred developing agent is potassium hydroquinone monosulfonate or sodium hydroquinone monosulfonate. The addition amount of these developing agents is about 1×10⁻⁵ to 2 mols/liter of a developer (hereinafter liter is also abbreviated as “L” hereinafter).

The black-and-white developer of the present invention can contain a preservative where necessary. As this preservative, sulfite or bisulfite is generally used. The addition amount is 0.01 to 1 mol/L, preferably 0.1 to 0.5 mol/L. Ascorbic acid is also an effective preservative, and its favored addition amount is 0.01 to 0.5 mol/L. It is also possible to use hydroxylamines represented by formula (I) in JP-A-3-144446, sugars, o-hydroxyketones, and hydrazines. The addition amount of these preservatives is 0.1 mol/L or less.

The pH of the black-and-white developer of the present invention is preferably 8 to 12 and most preferably 9 to 11. Various buffering agents can be used to maintain this pH. Preferred examples of the buffering agents are carbonate, phosphate, borate, 5-sulfosalicylate, hydroxybenzoate, glycine salt, N,N-dimethylglycine salt, leucine salt, norleucine salt, guanine salt, 3,4-dihydroxyphenylalanine salt, alanine salt, aminobutyrate, valine salt, and lycine salt. Carbonate, borate, and 5-sulfosalicylate are particularly preferred because they can keep the above-mentioned pH range and are inexpensive. These buffering agents can be used singly, and two or more types of them can be used together. To obtain a target pH, an acid and/or an alkali can be added.

As an acid, inorganic and organic water-soluble acids can be used. Examples are sulfuric acid, nitric acid, hydrochloric acid, acetic acid, propionic acid, and ascorbic acid. As an alkali, various hydroxides and ammonium salt can be added. Examples are potassium hydroxide, sodium hydroxide, ammonia water, triethanolamine, and diethanolamine.

The black-and-white developer used in the present invention preferably contains a silver halide solvent as a development accelerator. Favored examples are thiocyanate, sulfite, thiosulfate, 2-methylimidazole, and a thioether-based compound described in JP-A-57-63580. The addition amount of these compounds is preferably about 0.005 to 0.5 mol/L.

Other examples of the development accelerator are various quaternary amines, polyethyleneoxides, 1-phenyl-3-pyrazolidones, primary amines, and N,N,N′,N′-tetramethyl-p-phenylenediamine.

The black-and-white developer used in the present invention can also contain diethylene glycol, propylene glycol, polyethylene glycols, and amines such as diethanolamine and triethanolamine, as dissolution assistants; quaternary ammonium salt as a sensitizer; and various surfactants and film hardeners.

In the black-and-white development step of the present invention, various antifoggants can be added to prevent development fog. Preferred examples are alkali metal halides such as sodium chloride, potassium chloride, potassium bromide, sodium bromide, and potassium iodide, and organic antifoggants. As organic antifoggants, it is possible to use nitrogen-containing heterocyclic compounds such as benzotriazole, 6-nitrobenzimidazole, 5-nitroisoindazole, 5-methylbenzotriazole, 5-nitrobenzotriazole, 5-chloro-benzotriazole, 2-thiazolyl-benzimidazole, 2-thiazolylmethyl-benzimidazole, and hydroxyazaindolizine, mercapto-substituted heterocyclic compounds such as 1-phenyl-5-mercaptotetrazole, 2-mercaptobenzoimidazole, and 2-mercaptobenzothiazole, and mercapto-substituted aromatic compounds such as thiosalicylic acid. These antifoggants include those which flow out from a color reversal photographic material during processing and build up in the developer for the photographic material.

Of these compounds, the addition concentration of an iodide is about 5×10⁻⁶ to 5×10⁻⁴ mol/L. A bromide is also favorable to prevent fog. The concentration of a bromide is preferably 0.001 to 0.1 mol/L and more preferably about 0.01 to 0.05 mol/L.

In addition, the black-and-white developer of the present invention can contain swelling inhibitors (e.g., inorganic salts such as sodium sulfate and potassium sulfate) and water softeners.

As water softeners, it is possible to user various structures such as aminopolycarboxylic acid, aminopolyphosphonic acid, phosphonocarboxylic acid, and organic and inorganic phosphonic acids.

Although practical examples are presented below, water softeners are not restricted to these examples.

Ethylenediaminetetraacetic acid, nitrilotriacetic acid, hydroxyethyliminodiacetic acid, propylenediaminetetraacetic acid, diethylenetriaminepentaacetic acid, triethylenetetraminehexaacetic acid, nitrilo-N,N,N-trimethylenephosphonic acid, ethylenediamine-N,N,N′,N′-tetramethylenephosphonic acid, and 1-hydroxyethylidene-1,1-diphosphonic acid. Two or more types of these water hardeners can be used together. The addition amount is favorably 0.1 to 20 g/L and more favorably 0.5 to 10 g/L.

The standard processing time of black-and-white development is 6 min, and sensitization and desensitization can be performed by appropriately changing this processing time. The processing time is usually changed between 2 and 18 min. The processing temperature is 20° C. to 50° C., preferably 33° C. to 45° C. The replenishment rate of the black-and-white developer is 100 to 5,000 milliliters (hereinafter milliliter is to also referred to as “mL”), preferably about 200 to 2,500 mL per m² of a light-sensitive material.

In the processing of the present invention, a light-sensitive material is washed and/or rinsed as needed after black-and-white development. After that, the material is processed in a reversal processing step and subsequently color-developed.

A washing bath or rinsing bath can be a single bath. However, it is more favorable to use a multistage counterflow system using two or more tanks, in order to reduce the replenishment rate. “Washing” is a method by which a relatively large amount of water is replenished; “rinsing” is a method by which the replenishment rate is reduced to the level of other processing baths. The replenishment rate of the washing water is preferably about 3 to 20 L per m² of a light-sensitive material. The replenishment rate of the rinsing bath is preferably 50 mL to 2 L and more preferably about 100 to 500 mL; the use amount of water is greatly reduced compared to the washing step.

Also, to the rinsing bath of the present invention, it is possible to add, e.g., an oxidizer, chelating agent, buffering agent, germicide, and brightening agent as needed.

Subsequently, the material enters a reversal bath or a photo-fogging step. In the reversal bath, known fogging agents can be used as chemical fogging agents. Examples are stannous ion complex salts such as stannous ion-organic phosphoric acid complex salt (U.S. Pat. No. 3,617,282), stannous ion organic phosphonocarboxylic acid complex salt (JP-B-56-32616), and stannous ion-aminopolycarboxylic acid complex salt (U.S. Pat. No. 1,209,050); stannous ion complex salt of a chelating agent represented by formula (II) or (III) in JP-A-11-109573; and boron compounds such as a hydrogenated boron compound (U.S. Pat. No. 2,984,567) and a heterocyclic amineborane compound (British Patent 1,011,000). The pH of the reversal bath extends over a broad range from an acidic to an alkaline side in accordance with the type of fogging agent. This pH is usually 2 to 12, often 2.5 to 10, and most often 3 to 9.

The concentration of tin(II) in the reversal bath is 1×10⁻³ to 5×10⁻² mol/L, preferably 2×10⁻³ to 1.5×10⁻² mol/L.

To increase the solubility of the tin(II) chelate, the reversal bath preferably contains propionic acid, acetic acid, or an alkylenedicarboxylic acid compound represented by formula (I) in JP-A-11-109572. In addition, the reversal bath favorably contains sorbic acid salt and a quaternary ammonium compound described in U.S. Pat. No. 5,811,225 as antibacterial agents.

The time of the reversal bath is 10 sec to 3 min, preferably 20 sec to 2 min, and more preferably 30 to 90 sec. The temperature of the reversal bath is preferably at the temperature of any of first development, those of the subsequent rinsing or washing and color development, or within the temperature range of these bathes. This temperature is generally 20 to 50° C. and preferably 33 to 45° C.

The replenishment rate of the reversal bath is 10 to 2,000 mL, favorably 200 to 1,500 mL per m² of a photographic material.

The tin(II) chelate of the reversal bath achieves its effects over a wide pH range, so it is not particularly necessary to add another pH buffering agent. However, this does not prevent addition of acids, alkalis, and salts for imparting pH buffering properties. Examples are organic acids such as citric acid and malic acid, inorganic acids such as boric acid, sulfuric acid, and hydrochloric acid, alkali carbonate, caustic, borax, and potassium metaborate. It is also possible, if necessary, to add a water softener such as aminopolycarboxylic acid, a swell inhibitor such as sodium sulfate, and an antioxidant such as p-aminophenol.

After being processed in the reversal bath, the material enters a color development step. A color developer used in color development of the present invention is an alkaline aqueous solution containing an aromatic primary amine color developing agent as its main constituent. As this color developing agent, a p-phenylenediamine compound is preferably used. Representative examples of this p-phenylenediamine compound are 3-methyl-4-amino-N,N-diethylaniline, 3-methyl-4-amino-N-ethyl-N-βhydroxyethylaniline, 3-methyl-4-amino-N-ethyl-Nβ-methanesulfonamidoethylan iline, 3-methyl-4-amino-N-ethyl-Nβ-methoxyethylaniline, their sulfates, hydrochlorides, and phosphates, p-toluenesulfonate, tetraphenylborate, and p-(t-octyl)benzenesulfonate. Two or more types of these developing agents can be used together where necessary. The addition amount is preferably 0.005 to 0.1 mol/L and more preferably about 0.01 to 0.05 mol/L.

The pH of the color developer of the present invention is favorably 8 to 13 and most favorably 10.0 to 12.3, and especially preferably 11.5 to 12.3. Various buffering agents are used to maintain this pH.

As a buffering agent having a buffering region in the pH range of 8.0 or more used in the present invention, it is possible to use carbonate, phosphate, borate, 5-sulfosalicylate, tetraborate, hydroxybenzoate, glycine salt, N,N-dimethylglycine salt, leucine salt, norleucine salt, guanine salt, 3,4-dihydroxyphenylalanine salt, alanine salt, aminobutyrate, 2-amino-2-methyl-1,3-propanediol salt, valine salt, proline salt, trishydroxyaminomethane salt, and lycine salt. In particular, carbonate, borate, and 5-sulfosalicylate have advantages that they have high solubility and high buffering capacity in a high pH region of pH 10.0 or more, have no adverse effect (e.g., stain) on photographic properties even when added to a color developer, and are inexpensive. Hence, the use of these buffering agents is particularly preferred.

Practical examples of these buffering agents are sodium carbonate, potassium carbonate, sodium bicarbonate, potassium bicarbonate, trisodium phosphate, tripotassium phosphate, disodium phosphate, dipotassium phosphate, dipotassium 5-sulfosalicylate, sodium borate, potassium borate, sodium tetraborate (borax), potassium tetraborate, sodium o-hydroxybenzoate (sodium salicylate), potassium o-hydroxybenzoate, sodium 5-sulfo-2-hydroxybenzoate (sodium 5-sulfosalicylate), and potassium 5-sulfo-2-hydroxybenzoate (potassium 5-sulfosalicylate). Preferred examples are trisodium phosphate, tripotassium phosphate, disodium phosphate, dipotassium phosphate, dipotassium 5-sulfosalicylate, and disodium 5-sulfosalicylate.

These buffering agents can be singly added to the developer, and two or more types of them can be added together. Consequently, a target pH can be obtained by an alkali agent or an acid.

The amount of buffering agents added to the color developer is preferably 0.1 mol/L or more and particularly preferably 0.1 to 0.4 mol/L (as a total amount when they are used together).

In the present invention, various development accelerators can also be used as needed.

As development accelerators, it is possible to use diverse pyridinium compounds represented by U.S. Pat. No. 2,648,604, JP-B-44-9503, and U.S. Pat. No. 3,171,247 and other cationic compounds, cationic dyes such as phenosafranine, neutral salts such as thallium nitrate and potassium nitrate, polyethylene glycols and its derivatives described in JP-B-44-9304, U.S. Pat. Nos. 2,533,990, 2,531,832, 2,950,970, and 2,577,127, nonionic compounds such as polythioethers, and thioether-based compounds described in U.S. Pat. No. 3,201,242.

In addition, benzyl alcohol and its solvents, e.g., diethylene glycol, triethanolamine, and diethanolamine can be used where necessary. However, the use of these compounds is preferably as samall as possible when the environmental load, the solubility of a solution, and the generation of tar are taken into consideration.

A silver halide solvent similar to that of a black-and-white developer can also be contained. Examples are thiocyanate, 2-methylimidazole, and a thioether-based compound described in JP-A-57-63580. 3,6-dithiaoctane-1,8-diol is particularly favored.

In the color development step of the present invention, development fog need not be prevented. However, when running is performed while a color film is replenished, various antifoggants can also be contained to maintain the composition of a solution and the constancy of performance. Preferred examples of the antifoggants used in the development step are alkali metal halides such as potassium chloride, sodium chloride, potassium bromide, sodium bromide, and potassium iodide, and organic antifoggants. As organic antifoggants, it is possible to use nitrogen-containing heterocyclic compounds such as benzotriazole, 6-nitrobenzimidazole, 5-nitroisoindazole, 5-methylbenzotriazole, 5-nitrobenzotriazole, 5-chloro-benzotriazole, 2-thiazolyl-benzimidazole, 2-thiazolylmethyl-benzimidazole, and hydroxyazaindolizine, mercapto-substituted heterocyclic compounds such as 1-phenyl-5-mercaptotetrazole, 2-mercaptobenzimidazole, and 2-mercaptobenzothiazole, and mercapto-substituted aromatic compounds such as thiosalicylic acid. These antifoggants include those which flow out of a color reversal photgraphic material during processing and build up in these developers.

Various preservatives can be used in the color developer according to the present invention. Representative preservatives are hydroxylamines and sulfite, and sulfite is preferred. The addition amount of these preservatives is about 0 to 0.1 mol/L.

The color developer used in the present invention can contain organic preservatives instead of hydroxylamines and sulfurous acid ion described above.

“Organic preservatives” mean general organic compounds which reduce the deterioration rate of the aromatic primary amine color developing agent when added to a processing solution of a color photographic material. That is, organic preservatives are organic compounds having a function of preventing oxidation of the color developing agent by air and the like. Particularly effective organic preservatives are hydroxylamine derivatives (except for hydroxylamine), hydroxamic acids, hydrazines, hydrazides, phenols, α-hydroxyketones, α-aminoketones, sugars, monoamines, diamines, polyamines, quaternary ammonium salts, nitroxy radicals, alcohols, oximes, dialed compounds, and condensed-ring amines. These preservatives are disclosed in, e.g., JP-B-48-30496, JP-A's-52-143020, 63-4235, 63-30845, 63-21647, 63-44655, 63-53551, 63-43140, 63-56654, 63-58346, 63-43138, 63-146041, 63-44657, and 63-44656, U.S. Pat. Nos. 3,615,503 and 2,494,903, and JP-A's-1-97953, 1-186939, 1-186940, 1-187557, and 2-306244. As other preservatives, it is also possible to use, if necessary, various metals described in JP-A's-57-44148 and 57-53749, salicylic acids described in JP-A-59-180588, amines described in JP-A's-63-239447, 63-128340, 1-186939, and 1-187557, alkanolamines described in JP-A-54-3532, polyethyleneimines described in JP-A-56-94349, and aromatic polyhydroxy compounds described in U.S. Pat. No. 3,746,544. It is particularly preferable to add alkanolamines such as triethanolamine, dialkylhydroxylamine such as N,N-diethylhydroxylamine or N,N-di(sulfoethyl)hydroxylamine, a hydrazine derivative (except for hydrazine) such as N,N-bis(carboxymethyl)hydrazine, or an aromatic polyhydroxy compound represented by soda catechol-3,5-disulfonate.

The addition amount of these organic preservatives is preferably 0.02 to 0.5 mol/L and more preferably about 0.05 to 0.2 mol/L. Two or more types of these organic preservatives can be used together if necessary.

In addition, the color developer according to the present invention can contain organic solvents such as diethylene glycol and triethylene glycol; dye forming couplers; competing couplers such as citrazinic acid, J acid, and H acid; nucleating agents such as sodium boron hydride; auxiliary developing agents such as 1-phenyl-3-pyrazolidone; viscosity imparting agents; and chelating agents such as aminopolycarboxylic acids represented by ethylenediaminetetraacetic acid, nitrilotriacetic acid, cyclohexanediaminetetraacetic acid, hydroxyethyliminodiacetic acid, iminodiacetic acid, N-hydroxymethylethylenediaminetriacetic acid, diethylenetriaminepentaacetic acid, triethylenetetraminehexaacetic acid, and a compound described in JP-A-58-195845, 1-hydroxyethylidene-1,1′-diphosphonic acid, organic phosphonic acid described in Research Disclosure No. 18170 (May 1979), aminophosphonic acids such as aminotris(methylenephosphonic acid) and ethylenediamine-N,N,N′,N′-tetramethylenephosphonic acid, and phosphonocarboxylic acids described in JP-A's-52-102726, 53-42730, 54-121127, 55-4024, 55-4025, 55-126241, 55-65955, 55-65956, and Research Disclosure No. 18170 (May 1979). The addition amount of these chelating agents is 0.05 to 20 g/L, preferably about 0.1 to 5 g/L. Two or more types of these chelating agents can be used together where necessary.

It is also possible to add, as needed, various surfactants such as alkylsulfonic acid, arylsulfonic acid, aliphatic carboxylic acid, and aromatic carboxylic acid polyalkyleneimine.

The processing temperature of the color developer applicable to the present invention is 20 to 50° C., preferably 33 to 45° C. The processing time is 20 sec to 10 min, preferably 2 min to 6 min. The replenishment rate is preferably as small as possible provided that the activity can be maintained. This replenishment rate is appropriately 100 to 3,000 mL and preferably 400 to 2,200 mL per m² of a photographic material.

The color-developed color reversal photographic material is subsequently desilvered. This desilvering process is usually performed by the following steps.

1. (Color development)-adjustment-bleaching-fixing

2. (Color development)-washing-bleaching-fixing

3. (Color development)-bleaching-fixing

4. (Color development)-washing-bleaching-washing-fixing

5. (Color development)-bleaching-washing-fixing

6. (Color development) washing-bleach-fix

7. (Color development)-adjustment-bleach-fix

8. (Color development)-bleach-fixing

9. (Color development)-washing-bleaching-bleach-fix

10. (Color development)-bleaching-bleach-fix

11. (Color development)-washing-bleaching-bleach-fix-fixing

Of the above processes, 1, 2, 3, and 7 are preferred.

Regarding the replenishing method in the above processes, replenishing solutions for respective baths may be replenished to the corresponding baths as in conventional methods. In processes 9 and 10, it is possible to introduce an overflow solution of the bleaching solution to the bleach-fix bath and replenish only the fixing solution composition to the bleach-fix bath. In process 11, it is possible to use a method by which an overflow solution of the bleaching solution is introduced to the bleach-fix solution, an overflow solution of the fixing solution is introduced to the bleach-fix solution, and the two solutions are caused to overflow from the bleach-fix bath.

As a bleaching agent of the bleaching bath or the bleach-fix bath of the present invention, the currently most generally used is aminopolycarboxylic acid iron(III) complex salt. Representative examples of these aminopolycarboxylic acids and their salts are:

A-1 Ethylenediaminetetraacetic acid

A-2 Ethylenediaminetetraacetic acid disodium salt

A-3 Ethylenediaminetetraacetic acid diammonium salt

A-4 Diethylenetriaminepentaacetic acid

A-5 Cyclohexanediaminetetraacetic acid

A-6 Cyclohexanediaminetetraacetic acid disodium salt

A-7 Iminodiacetic acid

A-8 1,3-diaminopropane tetraacetic acid

A-9 Methyliminodiacetic acid

A-10 Hydroxyethyliminodiacetic acid

A-11 Glycoletherdiaminetetraacetic acid

A-12 Ethylenediaminetetrapropionic acid

A-13 N-(2-carboxyethyl)-iminodiacetic acid

A-14 Ethylenediaminedipropionic acid

A-15 β-alaninediacetic acid

A-16 Ethylenediaminedimalonic acid

A-17 Ethylenediaminedisuccinic acid

A-18 Propylenediaminedisuccinic acid

Aminopolycarboxylic acid ferric complex salt can be used in the form of complex salt, or ferric ion complex salt can be formed in a solution by using ferric salt and aminopolycarboxylic acid. In addition, one type or two or more types of aminopolycarboxylic acids can be used. In either case, aminocarboxylic acid more than necessary to form ferric ion complex salt can be used.

The bleaching solution or bleach-fix solution containing the above ferric ion complex can also contain metal ion complex salt, such as cobalt or copper, other than iron.

The addition amount of these bleaching agents is 0.02 to 0.5 mol, preferably 0.05 to 0.3 mol per L of a bath having bleaching capacity.

Various bleach-fix accelerators can be added to the bleaching bath and bleach-fix bath of the present invention.

Examples of these bleaching accelerators are diverse mercapto compounds as described in

U.S. Pat. No. 3,893,858, British Patent 1,138,842, and JP-A-53-141623, compounds having a disulfide bond as described in JP-A-53-95630, thiazolidine derivatives as described in JP-B-53-9854, isothiourea derivatives as described in JP-A-53-94927, thiourea derivatives as described in JP-B's-45-8506 and 49-26586, and thioamide compounds as described in JP-A-49-42349, and dithiocarbamates as described in JP-A-55-26506.

As a bleaching accelerator, it is also possible to use an alkylmercapto compound which is either unsubstituted or substituted by, e.g., a hydroxyl group, carboxyl group, sulfonic acid, or amino group (which can have a substituent such as an alkyl group or an acetoxyalkyl group). Examples are trithioglycerin, α, α′-thiodipropionic acid, and δ-mercaptobutyric acid. Furthermore, compounds described in U.S. Pat. No. 4,552,834 can be used.

The addition amount when a compound having a mercapto group or disulfide bond in the above molecule, a thiazoline derivative, or an isothiourea derivative is to be contained in an adjusting solution or a bleaching solution changes in accordance with, e.g., the type of photographic material to be processed, the processing temperature, and the time required for target processing. However, this amount is appropriately 1×10⁻⁵ to 10⁻¹ mol and preferably 1×10⁻⁴ to 5×10⁻² mol per L of a processing solution.

In addition to the bleaching agents and compounds described above, the bleaching solution used in the present invention can contain a rehalogenating agent, e.g., a bromide such as potassium bromide, sodium bromide, or ammonium bromide, or a chloride such as potassium chloride, sodium chloride, or ammonium chloride. Furthermore, known additives commonly used in a bleaching solution can be added to the bleaching solution of the present invention. Examples of these additives are one or more types of inorganic acids, organic acids, and their salts having pH buffering capacity. Practical examples are nitrate such as sodium nitrate and ammonium nitrate, boric acid, borax, sodium metaborate, acetic acid, sodium acetate, sodium carbonate, potassium carbonate, phosphorous acid, phosphoric acid, sodium phosphate, citric acid, sodium citrate, and tartaric acid.

The pH of a solution having bleaching capacity is preferably 4.0 to 8.0 and particularly preferably 5.0 to 7.0 when in use.

In the bleach-fix solution, one type or two or more types of water-soluble silver halide dissolving agents can be mixed as fixing agents. Examples are thiosulfate such as sodium thiosulfate and ammonium thiosulfate, thiocyanate such as sodium thiocyanate, ammonium thiocyanate, and potassium thiocyanate, thioether compounds such as ethylenebisthioglycolic acid and 3,6-dithia-1,8-octanediol, and thioureas. It is also possible to use a special bleach-fix solution, described in JP-A-55-155354, which is the combination of a fixing agent and a large amount of a halide such as potassium iodide. The amount of these fixing agents is 0.1 to 3 mols, preferably 0.2 to 2 mols per L of a bath having fixing capacity.

When a fixing solution is used in the present invention, its fixing agents can also be known fixing agents, i.e., water-soluble silver halide dissolving agents. Examples are thiosulfate such as sodium thiosulfate and ammonium thiosulfate, thiocyanate such as sodium thiocyanate, ammonium thiocyanate, and potassium thiocyanate, thioether compounds such as ethylenebisthioglycolic acid and 3,6-dithia-1,8-octanediol, and thioureas. One type or two or more types of these fixing agents can be mixed. The concentration of the fixing agent is 0.1 to 3 mols, preferably 0.2 to 2 mols per L of the fixing solution.

In addition to the aforementioned additives, a solution having fixing capacity can contain preservatives such as sulfite (e.g., sodium sulfite, potassium sulfite, and ammonium sulfite), bisulfite, hydroxylamine, hydrazine, and a bisulfite adduct of an aldehyde compound (e.g., sodium acetaldehyde bisulfite). Sulfinic acids (e.g., benzenesulfinic acid) and ascorbic acid are also effective preservatives.

Furthermore, a solution having bleaching capacity can contain various brightening agents, anti-foaming agents, surfactants, polyvinylpyrrolidone, antibacterial agents, antifungal agents, and organic solvents such as methanol.

The replenishment rate of each of the bleaching solution, fixing solution, bleach-fix solution, and the like in the present invention can be arbitrarily set as long as the functions of these processing baths are satisfied. The replenishment rate is preferably 30 to 2,000 mL and more preferably 50 to 1,000 mL per m² of a light-sensitive material.

The processing temperature is preferably 20° C. to 50° C. and more preferably 33° C. to 45° C. The processing time is 10 sec to 10 min, preferably 20 sec to 6 min.

After the desilvering process such as fixing or bleach-fix, washing and/or stabilization is generally performed. Although a stabilizing solution usually contains an image stabilizer, a stabilizing solution not containing any image stabilizer can also be used. A solution like this is sometimes called a rinsing solution (cleaning solution), in distinction from a stabilizing solution.

The amount of water used in the washing step can be set over a broad range in accordance with the characteristics (e.g., characteristics determined by materials used such as couplers) and the intended use of a photographic material, the temperature of the water, the number of water tanks (the number of stages), and other diverse conditions. The relationship between the amount of water and the number of water tanks in the multistage countercurrent system can be obtained by a method described in “Journal of the Society of Motion Picture and Television Engineering”, Vol. 64, pp. 248-253 (May, 1955). In the multistage countercurrent system, the number of stages is preferably 2 to 15 and particularly preferably 2 to 10.

By the multistage countercurrent system, the amount of washing water can be greatly decreased. Since washing water stays in the tanks for long periods of time, however, bacteria multiply and the floating substances produced attach to a light-sensitive material. To solve this problem, a method of reducing calcium and magnesium ions described in JP-A-62-288838 can be extremely effectively used. It is also possible to use an isothiazolone compound and cyabendazoles described in JP-A-57-8542, a chlorine-based germicide such as chlorinated sodium isocyanurate described in JP-A-61-120145, benzotriazole described in JP-A-61-267761, copper ion, and germicides described in Hiroshi Horiguchi et al., “Antibacterial and Antifungal Chemistry” (1986), Sankyo Shuppan, Eiseigijutsu-Kai ed., “Sterilization, Antibacterial, and Antifungal Techniques for Microorganisms” (1982), Kogyogijutsu-Kai, and Nippon Bokin Bokabi Gakkai ed., “Dictionary of Antibacterial and Antifungal Agents” (1986).

Furthermore, a surfactant as a hydro-extracting agent and a chelating agent represented by EDTA as a water softener can be used in washing water, a stabilizing solution, or a rinsing solution.

Examples of the surfactant are a polyethylglycol type nonionic surfactant, polyvalent alcohol type nonionic surfactant, alkylbenzenesulfonate type anionic surfactant, higher alcohol sulfate type anionic surfactant, alkylnaphthalenesulfonate type anionic surfactant, quaternary ammonium salt type cationic surfactant, amine salt type cationic surfactant, amino salt type amphoteric surfactant, and betaine type amphoteric surfactant. Two or more types of these surfactants can be used together. A fluorine-based surfactant or siloxane-based surfactant described in U.S. Pat. No. 5,716,765 can also be used.

Of the nonionic surfactants, alkylpolyethyleneoxides, alkylphenoxypolyethyleneoxides, and alkylphenoxypolyhydroxypropyleneoxides are preferred. A particularly preferred nonionic surfactant is 8- to 15-carbon, alkyl-polyethyleneoxide (5 to 12) alcohol.

To improve the solubility of a surfactant, it is also preferable to add solubilizers, e.g., amines such as diethanolamine and triethanolamine, and glycols such as diethylene glycol and propylene glycol.

It is preferable that chelating agents for collecting heavy metals be contained in the stabilizing solution or rinsing solution of the present invention, in order to improve the stability of the solution and reduce contamination. As chelating agents, the same compounds as added to the developer and the bleaching solution described above can be used.

To prevent mildew of bacteria, it is preferable to add antibacterial and antifungal agents to the stabilizing solution or rinsing solution of the present invention. For this purpose, commercially available antibacterial and antifungal agents can be used. Furthermore, surfactants, brightening agents, and film hardeners can be added.

The pH of the stabilizing solution, rinsing solution, and washing water of the present invention is 4 to 9, preferably 5 to 8. The processing temperature and the processing time can also be variously set in accordance with the characteristics and the intended use of a photographic material. In general, the processing temperature and the processing time are 15 to 45° C. and 20 sec to 10 min, preferably 25 to 40° C. and 30 sec to 4 min, respectively. Furthermore, the contamination preventing effect of the stabilizing solution or rinsing solution of the present invention significantly appears when processing is performed using the stabilizing solution or rinsing solution immediately after the desilvering process without performing washing.

The replenishment rate of the stabilizing solution or rinsing solution of the present invention is preferably 200 to 2,000 mL per m² of a photographic material. The overflow solutions produced by replenishment of the washing water and/or the stabilizing solution can also be reused in other steps such as the desilvering step.

To reduce the use amount of the washing water, ion exchange or ultrafiltration can be used. The use of ultrafiltration is particularly preferred. Various processing solutions of the present invention are used at 10° C. to 50° C. Although a temperature of 33° C. to 38° C. is usually a standard temperature, the processing time can be shortened by encouraging the processing by raising the temperature. Conversely, it is possible to improve the image quality or the stability of a processing solution by lowering the temperature.

In the processing of a photographic material according to the method of the present invention, when stabilization is to be immediately performed without any washing step, any known methods described in, e.g., JP-A's-57-8543, 58-14834, and 60-220345 can be used.

It is also favorable to use chelating agents such as 1-hydroxyethylidene-1,1-diphosphonic acid and ethylenediaminetetramethylenephosphonic acid, magnesium, and a bismuth compound.

Drying is performed following the washing and/or the stabilization step. To reduce the amount of water carried to an image film, drying can be accelerated by absorbing water by squeeze rollers or cloth immediately after the washing bath. Drying can also be naturally accelerated by improving the dryer, e.g., by increasing the temperature or strengthening the drying air by changing the shape of spray nozzles. In addition, as described in JP-A-3-157650, drying can be accelerated by adjusting the angle at which air is supplied to a light-sensitive material or improving a method of exhausting the air.

In the preparation method of the photographic material of the invention, photographically useful substances are usually added to the photographic coating solutions, i.e., hydrophilic colloid solutions.

Applicable various techniques and inorganic and organic materials usable in the silver halide photographic material and silver halide emulsions used therein are generally those described in Research Disclosure Item 308119 (1989), Item 37038 (1995), and Item 40145 (1997), the entire contents of which are incorporated herein by reference.

In addition, more specifically, techniques and inorganic and organic materials that can used in the color photosensitive materials of the present invention are described in portions of EP436,938A2 and patents cited below, the disclosures of which are incorporated herein by reference.

| Items | | Corresponding portions |
|---|---|---|
| 1) | Layer | page 146, line 34 to |
| | configurations | page 147, line 25 |
| 2) | Silver halide | page 147, line 26 to page 148 |
| | emulsions usable | line 12 |
| | together | |
| 3) | Yellow couplers | page 137, line 35 to |
| | usable together | page 146, line 33, and |
| | | page 149, lines 21 to 23 |
| 4) | Magenta couplers | page 149, lines 24 to 28; |
| | usable together | EP421, 453A1, page 3, line 5 |
| | | to page 25, line 55 |
| 5) | Cyan couplers | page 149, lines 29 to 33; |
| | usable together | EP432, 804A2, page 3, line 28 |
| | | to page 40, line 2 |
| 6) | Polymer couplers | page 149, lines 34 to 38; |
| | | EP435, 334A2, page 113, |
| | | line 39 to page 123, line 37 |
| 7) | Colored couplers | page 53, line 42 to page 137, |
| | | line 34, and page 149, |
| | | lines 39 to 45 |
| 8) | Functional couplers | page 7, line 1 to page 53, |
| | usable together | line 41, and page 149, |
| | | line 46 to page 150, line 3; |
| | | EP435, 334A2, page 3, line 1 |
| | | to page 29, line 50 |
| 9) | Antiseptic and | page 150, lines 25 to 28 |
| | mildewproofing | |
| | agents | |
| 10) | Formalin scavengers | page 149, lines 15 to 17 |
| 11) | Other additives | page 153, lines 38 to 47; |
| | usable together | EP421, 453A1, page 75, line 21 |
| | | to page 84, line 56, and |
| | | page 27, line 40 to page 37, |
| | | line 40 |
| 12) | Dispersion methods | page 150, lines 4 to 24 |
| 13) | Supports | page 150, lines 32 to 34 |
| 14) | Film thickness · | page 150, lines 35 to 49 |
| | film physical | |
| | properties | |
| 15) | Color development | page 150, line 50 to page |
| | step | 151, line 47 |
| 16) | Desilvering step | page 151, line 48 to page |
| | | 152, line 53 |
| 17) | Automatic processor | page 152, line 54 to page |
| | | 153, line 2 |
| 18) | Washing · stabilizing | page 153, lines 3 to 37 |
| | steps | |

The photographic material of the invention usually processed by an alkali developing solution containing a developing agent after it is exposed image-wisely. After this color development, the color photographic material is subjected to image-forming method by processed with a processing solution containing a bleaching agent having a bleaching ability.

### EXAMPLES

The present invention will be explained by way of examples, but the present invention is not limited to these.

### Example-1

Preparation of Sample 101

(1) Preparation of Triacetylcellulose Film

Triacetylcellulose was dissolved (13% by weight) by a common solution casting process in dichloromethane/methanol=92/8 (weight ratio), and triphenyl phosphate and biphenyldiphenyl phosphate in a weight ratio of 2:1, which are plasticizers, were added to the resultant solution so that the total amount of the plasticizers was 14% to the triacetylcellulose. Then, a triacetylcellulose film was made by a band process. The thickness of the support after drying was 205 μm.

(2) Components of Undercoat Layer

The two surfaces of the triacetylcellulose film were subjected to undercoating treatment. Numbers represent weight contained per liter of an undercoat solution.

The two surfaces of the triacetylcellulose film were subjected to corona discharge treatment before undercoating treatment.

| | | |
|---|---|---|
| Gelatin | 10.0 | g |
| Salicylic acid | 0.5 | g |
| Glycerin | 4.0 | g |
| Acetone | 700 | mL |
| Methanol | 200 | mL |
| Dichloromethane | 80 | mL |
| Formaldehyde | 0.1 | mg |
| Water to make | 1.0 | L |

(3) Coating of Back Layers

One surface of the undercoated support was coated with the following back layers.

| 1st layer | | |
|---|---|---|
| Binder: acid-processed gelatin | 1.00 | g |
| (isoelectric point: 9.0) | | |
| Polymeric latex: P-2 | 0.13 | g |
| (average grain size: 0.1 μm) | | |
| Polymeric latex: P-3 | 0.23 | g |
| (average grain size 0.2 μm) | | |
| Ultraviolet absorbent U-1 | 0.030 | g |
| Ultraviolet absorbent U-3 | 0.010 | g |
| Ultraviolet absorbent U-4 | 0.020 | g |
| High-boiling organic solvent Oil-2 | 0.030 | g |
| Surfactant W-3 | 0.010 | g |
| Surfactant W-6 | 3.0 | mg |
| 2nd layer | | |
| Binder: acid-processed gelatin | 3.10 | g |
| (isoelectric point: 9.0) | | |
| Polymeric latex: P-3 | 0.11 | g |
| (average grain size: 0.2 μm) | | |
| Ultraviolet absorbent U-1 | 0.030 | g |
| Ultraviolet absorbent U-3 | 0.010 | g |
| Ultraviolet absorbent U-4 | 0.020 | g |
| High-boiling organic solvent Oil-2 | 0.030 | g |
| Surfactant W-3 | 0.010 | g |
| Surfactant W-6 | 3.0 | mg |
| Dye D-2 | 0.10 | g |
| Dye D-10 | 0.12 | g |
| Potassium sulfate | 0.25 | g |
| Calcium chloride | 0.5 | mg |
| Sodium hydroxide | 0.03 | g |
| 3rd layer | | |
| Binder: acid-processed gelatin | 3.30 | g |
| (isoelectric point: 9.0) | | |
| Surfactant W-3 | 0.020 | g |
| Potassium sulfate | 0.30 | g |
| Sodium hydroxide | 0.03 | g |
| 4th layer | | |
| Binder: lime-processed gelatin | 1.15 | g |
| (isoelectric point: 5.4) | | |
| 1: 9 copolymer of methacrylic acid and | 0.040 | g |
| methylmethacrylate (average grain size: 2.0 μm) | | |
| 6: 4 copolymer of methacrylic acid and | 0.030 | g |
| methylmethacrylate (average grain size: 2.0 μm) | | |
| Surfactant W-3 | 0.060 | g |
| Surfactant W-2 | 7.0 | mg |
| Hardener H-1 | 0.23 | g |

(4) Coating of Photosensitive Emulsion Layers

Sample 101 was made by coating photosensitive emulsion layers presented below on the side opposite, against the support, to the side having the back layers. Numbers represent addition amounts per m² of the coating surface. Note that the effects of added compounds are not restricted to the described purposes.

| 1st layer: Antihalation layer | | |
|---|---|---|
| Black colloidal silver | 0.30 | g |
| Gelatin | 2.50 | g |
| Compound Cpd-F | 0.3 | g |
| High-boiling organic solvent Oil-6 | 0.1 | g |
| Dye D-4 | 1.0 | mg |
| Dye D-8 | 2.5 | mg |
| Fine crystal solid dispersion | 0.05 | g |
| of dye E-1 | | |
| 2nd layer: Interlayer | | |
| Gelatin | 0.80 | g |
| Compound Cpd-A | 0.2 | mg |
| Compound Cpd-K | 3.0 | mg |
| Compound Cpd-M | 0.030 | g |
| High-boiling organic solvent Oil-3 | 0.010 | g |
| High-boiling organic solvent Oil-4 | 0.010 | g |
| High-boiling organic solvent Oil-7 | 2.0 | mg |
| Dye D-7 | 4.0 | mg |
| 3rd layer: interlayer | | |
| Yellow colloidal silver | 0.020 | g |
| Gelatin | 0.60 | g |
| High-boiling organic solvent Oil-3 | 0.010 | g |
| High-boiling organic solvent Oil-8 | 0.010 | g |
| 4th layer: Low-speed red-sensitive emulsion layer | | |
| Emulsion A silver | 0.15 | g |
| Emulsion B silver | 0.20 | g |
| Emulsion C silver | 0.20 | g |
| Gelatin | 0.80 | g |
| Coupler C-1 | 0.10 | g |
| Coupler C-2 | 0.050 | g |
| Coupler C-3 | 0.020 | g |
| Compound Cpd-I | 0.020 | g |
| Compound Cpd-J | 2.0 | mg |
| High-boiling organic solvent Oil-2 | 0.070 | g |
| 5th layer: Medium-speed red-sensitive emulsion layer | | |
| Emulsion C silver | 0.30 | g |
| Emulsion D silver | 0.20 | g |
| Gelatin | 0.70 | g |
| Coupler C-1 | 0.15 | g |
| Coupler C-2 | 0.080 | g |
| Coupler C-3 | 0.020 | g |
| Coupler C-10 | 3.0 | mg |
| Ultraviolet absorbent U-3 | 0.010 | g |
| High-boiling organic solvent Oil-2 | 0.10 | g |
| 6th layer: High-speed red-sensitive emulsion layer | | |
| Emulsion E silver | 0.25 | g |
| Emulsion F silver | 0.30 | g |
| Gelatin | 1.70 | g |
| Coupler C-1 | 0.10 | g |
| Coupler C-2 | 0.10 | g |
| Coupler C-3 | 0.60 | g |
| High-boiling organic solvent Oil-2 | 0.050 | g |
| Compound Cpd-K | 1.0 | mg |
| Compound Cpd-L | 1.0 | mg |
| Additive P-1 | 0.010 | g |
| 7th layer: Interlayer | | |
| Gelatin | 0.70 | g |
| Additive P-2 | 0.10 | g |
| Dye D-5 | 0.020 | g |
| Dye D-9 | 6.0 | mg |
| Compound Cpd-I | 0.010 | g |
| Compound Cpd-M | 0.040 | g |
| Compound Cpd-O | 3.0 | mg |
| Compound Cpd-P | 5.0 | mg |
| High-boiling organic solvent Oil-6 | 0.050 | g |
| 8th layer: Interlayer | | |
| Yellow colloidal silver silver | 0.020 | g |
| Gelatin | 1.00 | g |
| Additive P-2 | 0.05 | g |
| Compound Cpd-A | 0.050 | g |
| Compound Cpd-D | 0.030 | g |
| Compound Cpd-M | 0.050 | g |
| High-boiling organic solvent Oil-3 | 0.010 | g |
| High-boiling organic solvent Oil-6 | 0.050 | g |
| 9th layer: Low-speed green-sensitive emulsion layer | | |
| Emulsion G silver | 0.30 | g |
| Emulsion H silver | 0.35 | g |
| Emulsion I silver | 0.30 | g |
| Gelatin | 1.70 | g |
| Coupler C-4 | 0.050 | g |
| Coupler C-5 | 0.050 | g |
| Coupler C-11 | 0.10 | g |
| Compound Cpd-A | 5.0 | mg |
| Compound Cpd-B | 0.030 | g |
| Compound Cpd-D | 5.0 | mg |
| Compound Cpd-G | 2.5 | mg |
| Compound Cpd-F | 0.010 | g |
| Compound Cpd-K | 2.0 | mg |
| Ultraviolet absorbent U-6 | 5.0 | mg |
| High-boiling organic solvent Oil-2 | 0.15 | g |
| High-boiling organic solvent Oil-5 | 0.030 | g |
| Additive P-1 | 5.0 | mg |
| 10th layer: Medium-speed green-sensitive emulsion layer | | |
| Emulsion I silver | 0.30 | g |
| Emulsion J silver | 0.30 | g |
| Gelatin | 0.70 | g |
| Coupler C-4 | 0.050 | g |
| Coupler C-6 | 0.050 | g |
| Coupler C-7 | 0.010 | g |
| Coupler C-11 | 0.20 | g |
| Compound Cpd-A | 5.0 | mg |
| Compound Cpd-B | 0.030 | g |
| Compound Cpd-F | 0.010 | g |
| Compound Cpd-G | 2.0 | mg |
| High-boiling organic solvent Oil-2 | 0.030 | g |
| 11th layer: High-speed green-sensitive emulsion layer | | |
| Emulsion K silver | 0.60 | g |
| Gelatin | 0.80 | g |
| Coupler C-6 | 0.20 | g |
| Coupler C-11 | 0.20 | g |
| Compound Cpd-A | 5.0 | mg |
| Compound Cpd-B | 0.030 | g |
| Compound Cpd-F | 0.010 | g |
| High-boiling organic solvent Oil-2 | 0.030 | g |
| 12th layer: Yellow filter layer | | |
| Yellow colloidal silver silver | 0.010 | g |
| Gelatin | 1.0 | g |
| Compound Cpd-C | 0.010 | g |
| Compound Cpd-M | 0.10 | g |
| High-boiling organic solvent Oil-1 | 0.020 | g |
| High-boiling organic solvent Oil-6 | 0.10 | g |
| Fine crystal solid dispersion | 0.20 | g |
| of dye E-2 | | |
| 13th layer: Interlayer | | |
| Gelatin | 0.40 | g |
| Dye D-6 | 5.0 | mg |
| Compound Cpd-Q | 0.20 | g |
| 14th layer: Low-speed blue-sensitive emulsion layer | | |
| Emulsion L silver | 0.10 | g |
| Emulsion M silver | 0.20 | g |
| Emulsion N silver | 0.15 | g |
| Gelatin | 1.30 | g |
| Coupler C-8 | 0.020 | g |
| Coupler C-9 | 0.30 | g |
| Coupler C-10 | 5.0 | mg |
| Compound Cpd-B | 0.10 | g |
| Compound Cpd-K | 1.0 | mg |
| Compound Cpd-M | 0.010 | g |
| Ultraviolet absorbent U-6 | 0.010 | g |
| High-boiling organic solvent Oil-2 | 0.010 | g |
| 15th layer: Medium-speed blue-sensitive emulsion layer | | |
| Emulsion N silver | 0.15 | g |
| Emulsion O silver | 0.20 | g |
| Gelatin | 0.80 | g |
| Coupler C-8 | 0.020 | g |
| Coupler C-9 | 0.25 | g |
| Coupler C-10 | 0.010 | g |
| Compound Cpd-B | 0.10 | g |
| Compound Cpd-N | 2.0 | mg |
| High-boiling organic solvent Oil-2 | 0.010 | g |
| 16th layer: High-speed blue-sensitive emulsion layer | | |
| Emulsion P silver | 0.25 | g |
| Emulsion Q silver | 0.25 | g |
| Gelatin | 2.00 | g |
| Coupler C-3 | 5.0 | mg |
| Coupler C-8 | 0.10 | g |
| Coupler C-9 | 1.00 | g |
| Coupler C-10 | 0.020 | g |
| High-boiling organic solvent Oil-2 | 0.050 | g |
| High-boiling organic solvent Oil-9 | 0.050 | g |
| Ultraviolet absorbent U-6 | 0.10 | g |
| Compound Cpd-N | 5.0 | mg |
| Compound Cpd-E | 0.10 | g |
| 17th layer: 1st protective layer | | |
| Gelatin | 1.00 | g |
| Ultraviolet absorbent U-1 | 0.15 | g |
| Ultraviolet absorbent U-2 | 0.050 | g |
| Ultraviolet absorbent U-5 | 0.20 | g |
| Compound Cpd-O | 5.0 | mg |
| Compound Cpd-A | 0.030 | g |
| Compound Cpd-H | 0.20 | g |
| Dye D-1 | 8.0 | mg |
| Dye D-2 | 0.010 | g |
| Dye D-3 | 0.010 | g |
| High-boiling organic solvent Oil-3 | 0.10 | g |
| 18th layer: 2nd protective layer | | |
| Colloidal silver silver | 2.5 | mg |
| Fine grain silver iodobromide emulsion (average | 0.10 | g |
| Grain size: 0.06 μm, AgI content: 1 mol %) | | |
| Gelatin | 0.80 | g |
| Ultraviolet absorbent U-1 | 0.030 | g |
| Ultraviolet absorbent U-6 | 0.030 | g |
| High-boiling organic solvent Oil-3 | 0.010 | g |
| 19th layer: 3rd protective layer | | |
| Gelatin | 1.00 | g |
| Polymethylmethacrylate | 0.10 | g |
| (average grain size 1.5 μm) | | |
| 6: 4 copolymer of methylmethacrylate and | 0.15 | g |
| methacrylic acid (average grain size 1.5 μm) | | |
| Silicone oil SO-1 | 0.20 | g |
| Surfactant W-1 | 3.0 | mg |
| Surfactant W-2 | 8.0 | mg |
| Surfactant W-3 | 0.040 | g |
| Surfactant W-7 | 0.015 | g |

In addition to the above compositions, additives F-1 to F-9 were added to all emulsion layers. Also, a gelatin hardener H-1 and surfactants W-3, W-4, W-5, and W-6 for coating and emulsification were added to each layer.

Furthermore, phenol, 1,2-benzisothiazoline-3-one, 2-phenoxyethanol, phenethylalcohol, and p-benzoic butylester were added as antiseptic and mildewproofing agents.

TABLE 1
Silver iodobromide emulsions used in sample 101

| | | | | | Structure | | | | | | |
|---|---|---|---|---|---|---|---|---|---|---|---|
| | | | | | in halide | AgI content | | | | | |
| | | Av. | | Av. AgI | composition | at grain | | | | | |
| Emul- | | ESD | COV | content | of silver | surface | Other characteristics | | | | |
| sion | Characteristics | (μm) | (%) | (mol %) | halide grains | (mol %) | (1) | (2) | (3) | (4) | (5) |
| A | Monodispersed | 0.24 | 10 | 3.5 | Double | 1.5 | | ∘ | | | |
| | tetradecahedral | | | | structure | | | | | | |
| | grains | | | | | | | | | | |
| B | Monodispersed (111) | 0.25 | 10 | 3.5 | Triple | 1.5 | | ∘ | | ∘ | ∘ |
| | tabular grains | | | | structure | | | | | | |
| | Av. aspect ratio 3.0 | | | | | | | | | | |
| C | Monodispersed (111) | 0.30 | 19 | 3.5 | Triple | 0.1 | | ∘ | | | |
| | tabular grains | | | | structure | | | | | | |
| | Av. aspect ratio 8.0 | | | | | | | | | | |
| D | Monodispersed (111) | 0.40 | 21 | 4.0 | Triple | 2.0 | ∘ | ∘ | | ∘ | ∘ |
| | tabular grains | | | | structure | | | | | | |
| | Av. aspect ratio 8.0 | | | | | | | | | | |
| E | Monodispersed (111) | 0.50 | 10 | 1.0 | Quadruple | 1.5 | | ∘ | | | |
| | tabular grains | | | | structure | | | | | | |
| | Av. aspect ratio 10.0 | | | | | | | | | | |
| F | Monodispersed (111) | 0.70 | 12 | 1.6 | Triple | 0.6 | ∘ | ∘ | | | ∘ |
| | tabular grains | | | | structure | | | | | | |
| | Av. aspect ratio 10.5 | | | | | | | | | | |
| G | Monodispersed cubic | 0.15 | 9 | 3.5 | Triple | 2.0 | | | ∘ | | |
| | grains | | | | structure | | | | | | |
| H | Monodispersed (111) | 0.25 | 12 | 3.9 | Quadruple | 0.8 | | ∘ | | ∘ | |
| | tabular grains | | | | structure | | | | | | |
| | Av. aspect ratio 4.0 | | | | | | | | | | |
| I | Monodispersed (111) | 0.35 | 12 | 3.5 | Quintuple | 4.5 | | ∘ | | ∘ | ∘ |
| | tabular grains | | | | structure | | | | | | |
| | Av. aspect ratio 4.0 | | | | | | | | | | |
| J | Monodispersed (111) | 0.45 | 21 | 3.0 | Quadruple | 0.2 | ∘ | ∘ | | | ∘ |
| | tabular grains | | | | structure | | | | | | |
| | Av. aspect ratio 10.0 | | | | | | | | | | |
| K | Monodispersed (111) | 0.65 | 13 | 2.7 | Triple | 1.3 | ∘ | ∘ | | | ∘ |
| | tabular grains | | | | structure | | | | | | |
| | Av. aspect ratio 10.5 | | | | | | | | | | |
| L | Monodispersed | 0.31 | 9 | 75 | Triple | 7.0 | | | ∘ | | ∘ |
| | tetradecahedral | | | | structure | | | | | | |
| | grains | | | | | | | | | | |
| M | Monodispersed (111) | 0.31 | 9 | 5.0 | Quadruple | 3.0 | ∘ | | | ∘ | ∘ |
| | tabular grains | | | | structure | | | | | | |
| | Av. aspect ratio 7.0 | | | | | | | | | | |
| N | Monodispersed (111) | 0.33 | 13 | 2.1 | Quadruple | 4.0 | ∘ | ∘ | ∘ | | |
| | tabular grains | | | | structure | | | | | | |
| | Av. aspect ratio 10.0 | | | | | | | | | | |
| O | Monodispersed (111) | 0.50 | 9 | 2.5 | Quadruple | 1.0 | | ∘ | | | ∘ |
| | tabular grains | | | | structure | | | | | | |
| | Av. aspect ratio 12.0 | | | | | | | | | | |
| P | Monodispersed (111) | 0.75 | 21 | 2.8 | Triple | 0.5 | ∘ | ∘ | | | ∘ |
| | tabular grains | | | | structure | | | | | | |
| | Av. aspect ratio 12.0 | | | | | | | | | | |
| Q | Monodispersed (111) | 0.85 | 8 | 1.0 | Quadruple | 0.5 | ∘ | ∘ | | | ∘ |
| | tabular grains | | | | structure | | | | | | |
| | Av. aspect ratio 12.0 | | | | | | | | | | |

Av. ESD = Equivalent sphere average grain size; COV = Coefficient of variation
(Other characteristics)
The mark “∘” means each of the conditions set forth below is satisfied.
(1) A reduction sensitizer was added during grain formation;
(2) A selenium sensitizer was used as an after-ripening agent
(3) A rhodium salt was added during grain formation.
(4) A shell was provided subsequent to after-ripening by using silver nitrate in an amount of 10%, in terms of silver molar ratio, of the emulsion grains at that time, together with the equimolar amount of potassium bromide
(5) The presence of dislocation lines in an average number of ten of ten or more per grain was observed by a transmission electron microscope.
Note that all the lightsensitive emulsion were after-ripped by the use of sodium thiosulfate, sodium thiocyanate, and sodium aurichloride.
Note, also, a iridium salt was added during grain formation.
Note, also, that chemically-modified gelatin whose amino groups were partially converted to phthalic acid amide, was added to emulsions B, C, E, H, J, N, and Q.

TABLE 2
Spectral sensitization of emulsions A to P

| | Spectral | Addition amount per mol | Timing of the addition of |
|---|---|---|---|
| Emulsion | sensitizer added | of silver halide (g) | the spectral sensitizer |
| A | S-1 | 0.01 | Before after-ripening |
| | S-2 | 0.20 | Before after-ripening |
| | S-3 | 0.02 | Before after-ripening |
| | S-8 | 0.25 | Before after-ripening |
| | S-13 | 0.015 | Before after-ripening |
| | S-14 | 0.01 | Before after-ripening |
| B | S-2 | 0.20 | Before after-ripening |
| | S-3 | 0.02 | Before after-ripening |
| | S-8 | 0.20 | Before after-ripening |
| | S-13 | 0.015 | Before after-ripening |
| | S-14 | 0.01 | Before after-ripening |
| C | S-2 | 0.025 | Before after-ripening |
| | S-3 | 0.04 | Before after-ripening |
| | S-8 | 0.25 | Before after-ripening |
| | S-13 | 0.02 | Before after-ripening |
| | S-14 | 0.04 | Before after-ripening |
| D | S-2 | 0.25 | Before after-ripening |
| | S-3 | 0.03 | Before after-ripening |
| | S-8 | 0.25 | Before after-ripening |
| | S-13 | 0.01 | Before after-ripening |
| E | S-1 | 0.01 | Subsequent to after-ripening |
| | S-2 | 0.20 | Before after-ripening |
| | S-3 | 0.05 | Before after-ripening |
| | S-8 | 0.25 | Before after-ripening |
| | S-13 | 0.01 | Before after-ripening |
| F | S-2 | 0.20 | Before after-ripening |
| | S-3 | 0.04 | Before after-ripening |
| | S-8 | 0.20 | Before after-ripening |
| | S-14 | 0.02 | Before after-ripening |
| G | S-4 | 0.3 | Subsequent to after-ripening |
| | S-5 | 0.05 | Subsequent to after-ripening |
| | S-12 | 0.1 | Subsequent to after-ripening |
| H | S-4 | 0.2 | Before after-ripening |
| | S-5 | 0.05 | Before after-ripening |
| | S-9 | 0.15 | Before after-ripening |
| | S-14 | 0.02 | Before after-ripening |
| I | S-4 | 0.3 | Before after-ripening |
| | S-9 | 0.2 | Before after-ripening |
| | S-12 | 0.1 | Before after-ripening |
| J | S-4 | 0.35 | Before after-ripening |
| | S-5 | 0.05 | Subsequent to after-ripening |
| | S-12 | 0.1 | Subsequent to after-ripening |
| K | S-4 | 0.3 | Before after-ripening |
| | S-9 | 0.05 | Before after-ripening |
| | S-12 | 0.1 | Before after-ripening |
| | S-14 | 0.02 | Before after-ripening |
| L, M | S-6 | 0.1 | Subsequent to after-ripening |
| | S-10 | 0.2 | Subsequent to after-ripening |
| | S-11 | 0.05 | Subsequent to after-ripening |
| N | S-6 | 0.05 | Subsequent to after-ripening |
| | S-7 | 0.05 | Subsequent to after-ripening |
| | S-10 | 0.25 | Subsequent to after-ripening |
| O | S-10 | 0.4 | Subsequent to after-ripening |
| | S-11 | 0.15 | Subsequent to after-ripening |
| P | S-6 | 0.05 | Subsequent to after-ripening |
| | S-7 | 0.05 | Before after-ripening |
| | S-10 | 0.3 | Before after-ripening |
| | S-11 | 0.1 | Before after-ripening |
| Q | S-6 | 0.05 | Before after-ripening |
| | S-7 | 0.05 | Before after-ripening |
| | S-10 | 0.2 | Before after-ripening |
| | S-11 | 0.25 | Before after-ripening |

| | |
|---|---|
| C-1 | 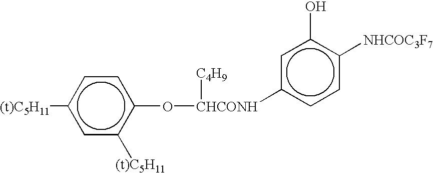 |
| C-2 | 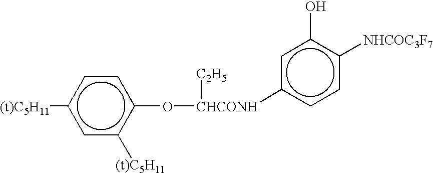 |
| C-3 | 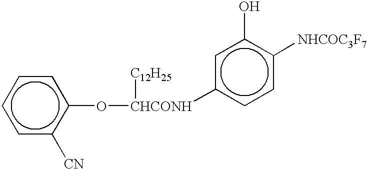 |
| C-4 | 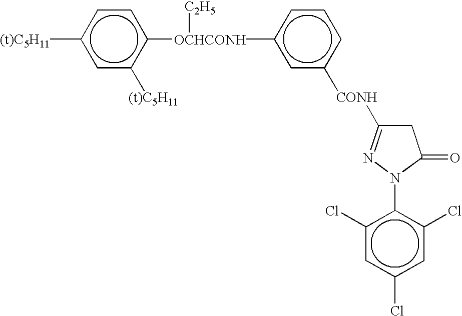 |
| C-5 | 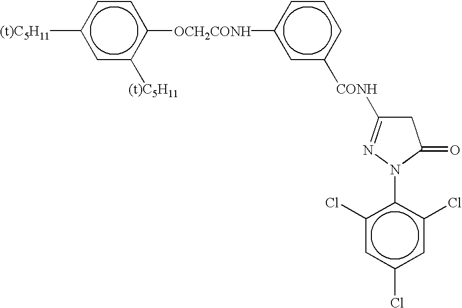 |
| C-6 | 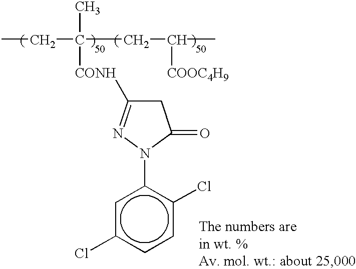 |
| C-7 | 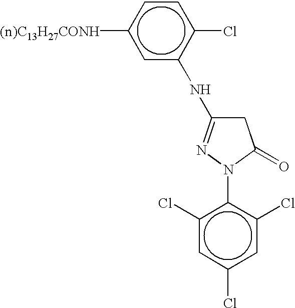 |
| C-8 | 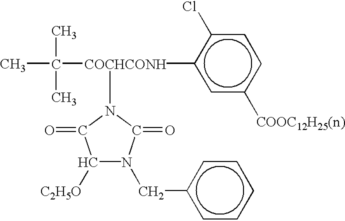 |
| C-9 | 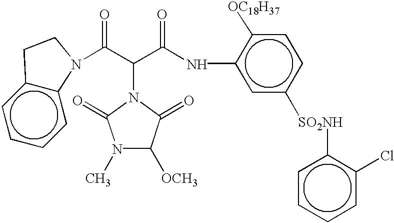 |
| C-10 | 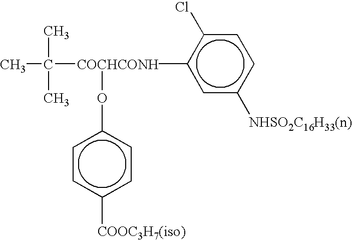 |
| C-11 | 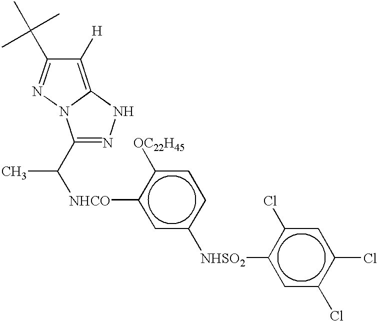 |

| Oil-1 | Tri-n-hexyl phosphate | Oil-2 | Tricresyl phosphate |
|---|---|---|---|
| Oil-3 | 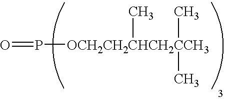 | | |
| Oil-4 | Cyclohexyl phospate | Oil-5 | Bis(2-ethylhexyl) succinate |
| Oil-6 | 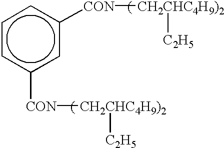 | Oil-7 | 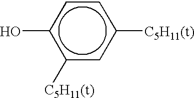 |
| Oil-8 | 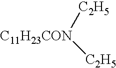 | Oil-9 | 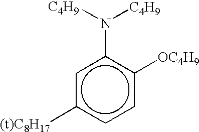 |

| Oil-10 | 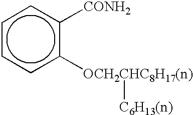 | | |
|---|---|---|---|
| Cpd-A | 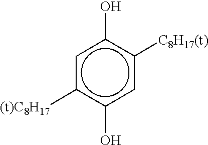 | | |
| Cpd-B | 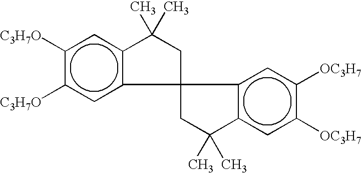 | | |
| Cpd-C | 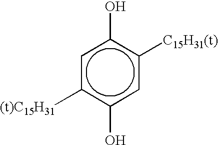 | Cpd-D | 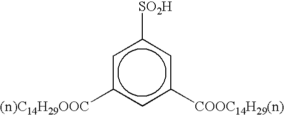 |
| Cpd-E | 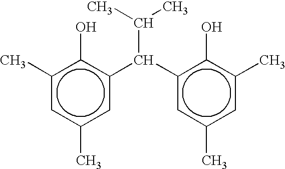 | Cpd-F | 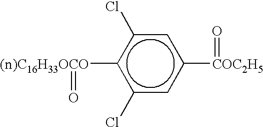 |
| Cpd-G | 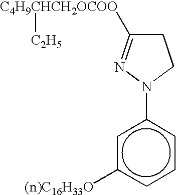 | Cpd-H | 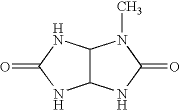 |
| Cpd-I | 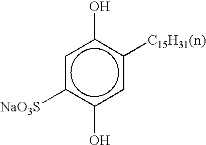 | | |
| Cpd-J | 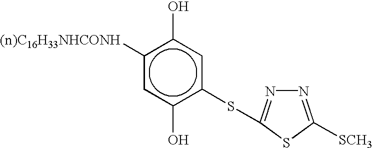 | | |
| Cpd-K | 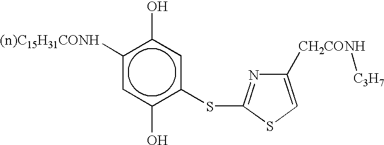 | | |
| Cpd-L | 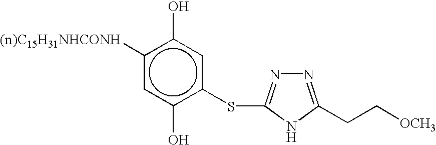 | | |
| Cpd-M | 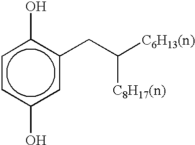 | | |
| Cpd-N | 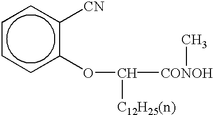 | Cpd-O | 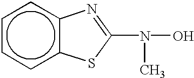 |
| Cpd-P | 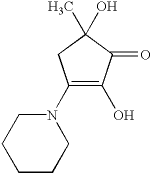 | Cpd-Q | 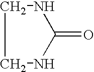 |

| | | | |
|---|---|---|---|
| U-1 | 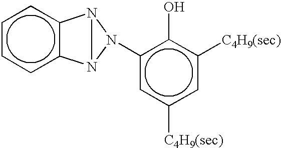 | U-2 | 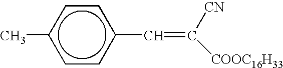 |
| U-3 | 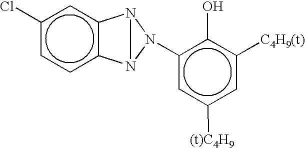 | U-4 | 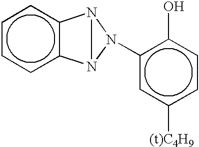 |
| U-5 | 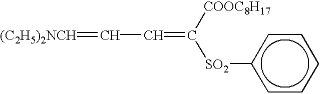 | U-6 | 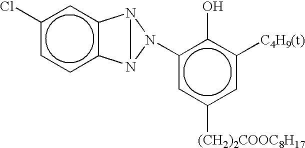 |

| S-1 | 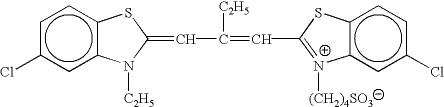 | | |
|---|---|---|---|
| S-2 | 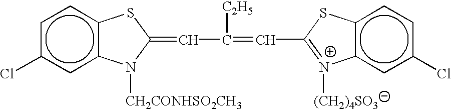 | | |
| S-3 | 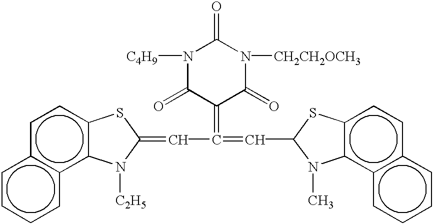 | | |
| S-4 | 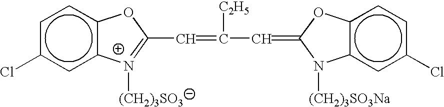 | | |
| S-5 | 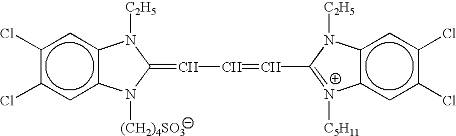 | | |
| S-6 | 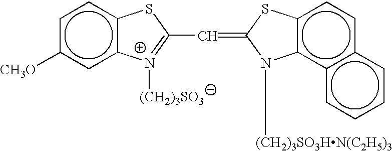 | | |
| S-7 | 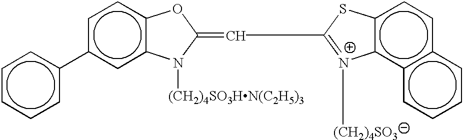 | | |
| S-8 | 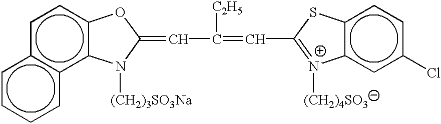 | | |
| S-9 | 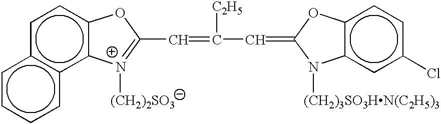 | | |
| S-10 | 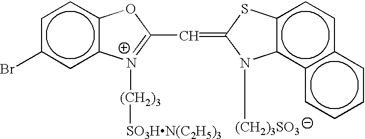 | | |
| S-11 | 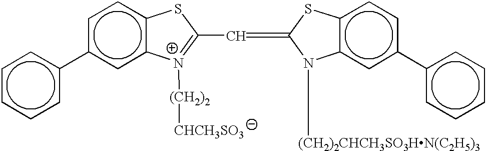 | | |
| S-12 | 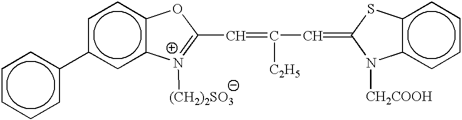 | | |
| S-13 | 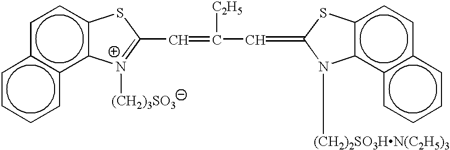 | | |
| S-14 | 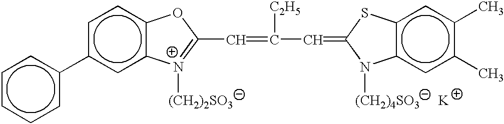 | | |
| D-1 | 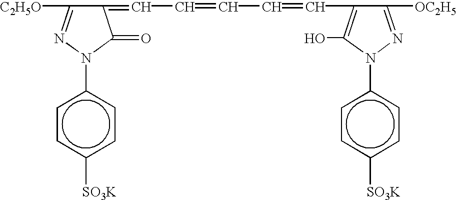 | | |
| D-2 | 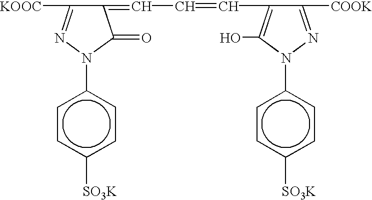 | | |
| D-3 | 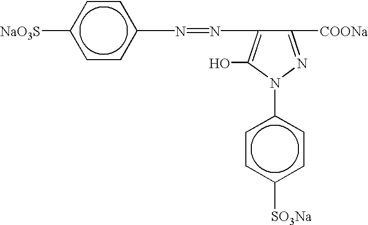 | | |
| D-4 | 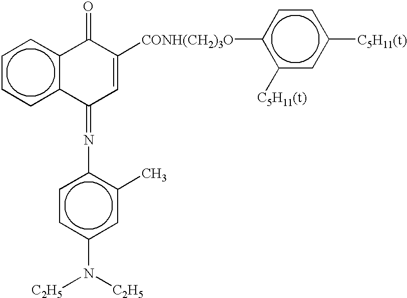 | | |
| D-5 | 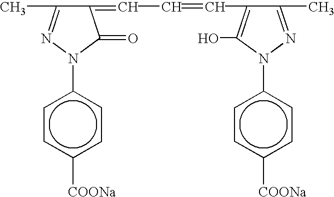 | | |
| D-6 | 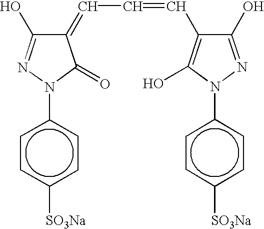 | D-7 | 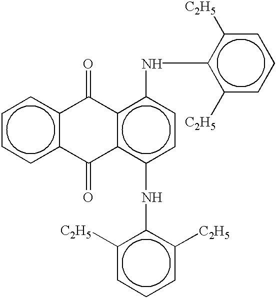 |

| D-8 | 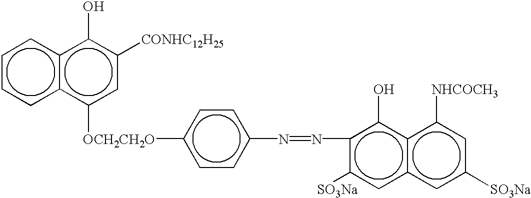 | | |
|---|---|---|---|
| D-9 | 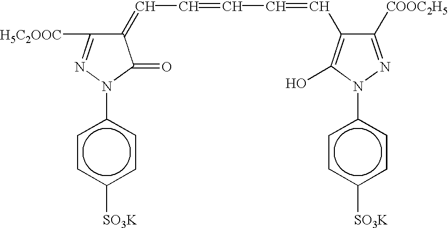 | | |
| D-10 | 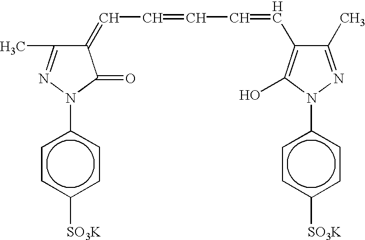 | | |
| E-1 | 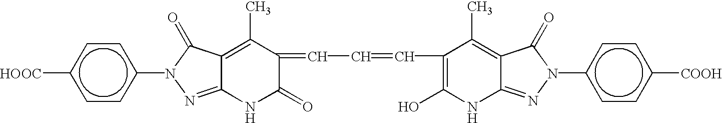 | | |
| E-2 | 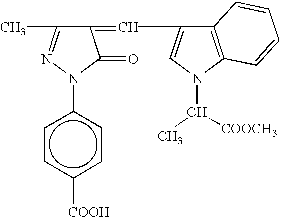 | | |
| H-1 | 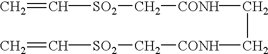 | | |
| W-1 | 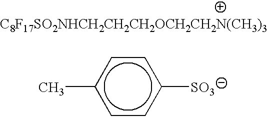 | W-2 | 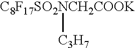 |
| W-3 | 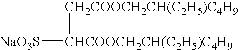 | W-4 | 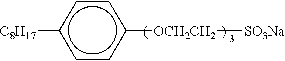 |
| W-5 | 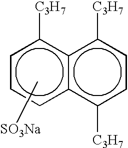 | W-6 | 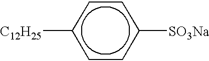 |
| W-7 | C₈F₁₇SO₃Li | | |
| P-1 | 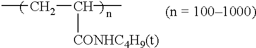 | P-2 | 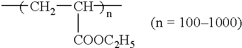 |

| P-3 | 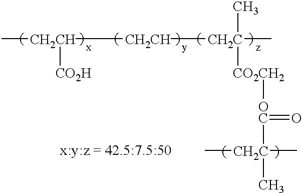 | | |
|---|---|---|---|
| F-1 | 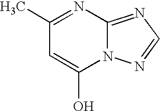 | F-2 | 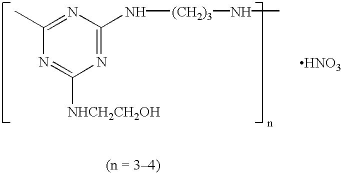 |

| | | | | | | | |
|---|---|---|---|---|---|---|---|
| F-3 | 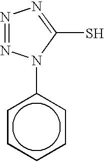 | F-4 | 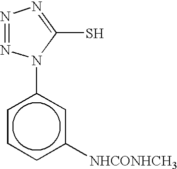 | F-5 | 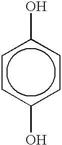 | F-6 | 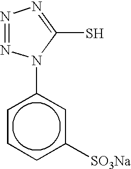 |

| | | | | | |
|---|---|---|---|---|---|
| F-7 | 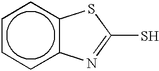 | F-8 | 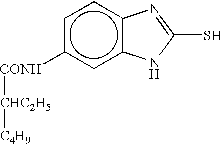 | F-9 | 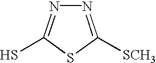 |

| | |
|---|---|
| SQ-1 | 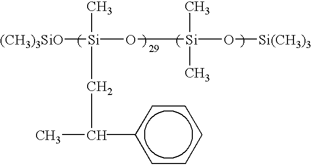 |

Preparation of Organic Solid Dispersed Dye

(Preparation of Dispersion of Dye E-1)

100 g of Pluronic F88 (an ethylene oxide-propylene oxide block copolymer) manufactured by BASF CORP. and water were added to a wet cake of the dye E-1 (the net weight of E-1 was 270 g), and the resultant material was stirred to make 4,000 g. Next, the Ultra Visco Mill (UVM-2) manufactured by Imex K.K. was filled with 1,700 mL of zirconia beads with an average grain size of 0.5 mm, and the slurry was milled through this UVM-2 at a peripheral speed of approximately 10 m/sec and a discharge rate of 0.5 L/min for 2 hr. The beads were filtered out, and water was added to dilute the material to a dye concentration of 3%. After that, the material was heated to 90° C. for 10 hr for stabilization. The average grain size of the obtained fine dye grains was 0.30 μm, and the grain size distribution (grain size standard deviation×100/average grain size) was 20%.

(Preparation of Dispersion of Dye E-2)

Water and 270 g of W-4 were added to 1,400 g of a wet cake of E-2 containing 30 weight % of water, and the resultant material was stirred to form a slurry having an E-2 concentration of 40 weight %. Next, the Ultra Visco Mill (UVM-2) manufactured by Imex K.K. was filled with 1,700 mL of zirconia beads with an average grain size of 0.5 mm, and the slurry was milled through this UVM-2 at a peripheral speed of approximately 10 m/sec and a discharge rate of 0.5 L/min for 8 hr, thereby obtaining a solid fine-grain dispersion of E-2. This dispersion was diluted to 20 weight % by ion exchange water to obtain a fine crystalline solid dispersion. The average grain size was 0.15 μm.

Subsequently, samples 102 to 125 were prepared by replacing Couplers C-1, -2 and -3 and the high-boiling organic solvent in the 4th, 5th and 6th layers of sample 101 as shown in Table 3 and adding the compounds shown in Table 3 to the 1st, 2nd and 3rd layers and the 4th, 5th and 6th layers. Note that Coupler C-10 in the 5th layer was not replaced.

In the replacement of couplers, the coupler of the present invention was replaced so that the amount thereof becomes 50%, in molar ratio, for C-1 and C-2, and 55%, in molar ratio, for C-3. The additives other than those particularly indicated were not changed from sample 101.

TABLE 3
Configuration of samples

| | | 4th, 5th and 6th layers | | |
|---|---|---|---|---|
| | | | High-boiling | Additive |
| | | | organic solvent | (based on the |
| Sample | | | (wt. ratio based | coupler in |
| No. | Remarks | Coupler | on the coupler) | mol %) |
| 101 | Comparison | As described | | |
| | | in the text | | |
| 102 | Comparison | (36) | Oil-10 (0.3) | none |
| 103 | Invention | (36) | Oil-10 (0.3) | SC-I-2 (10) |
| 104 | Invention | (36) | Oil-10 (0.3) | SC-I-6 (10) |
| 105 | Invention | (36) | Oil-10 (0.3) | SC-II-1 (10) |
| 106 | Invention | (36) | Oil-10 (0.3) | SC-II-2 (10) |
| 107 | Invention | (36) | Oil-10 (0.3) | SC-II-5 (10) |
| 108 | Invention | (36) | Oil-10 (0.3) | SC-III-1 (10) |
| 109 | Invention | (36) | Oil-10 (0.3) | SC-III-3 (10) |
| 110 | Invention | (36) | Oil-10 (0.3) | SC-IV-2 (10) |
| 111 | Invention | (36) | Oil-10 (0.3) | SC-IV-7 (10) |
| 112 | Invention | (36) | Oil-10 (0.3) | SC-V-1 (10) |
| 113 | Invention | (36) | Oil-10 (0.3) | SC-V-4 (10) |
| 114 | Invention | (36) | Oil-10 (0.3) | SC-V-8 (10) |
| | | In the following samples, compound Cpd-D | | |
| | | was added to 4th, 5th and 6th layers in an | | |
| | | amount of 3 mol % based on the coupler | | |
| 115 | Invention | (36) | Oil-10 (0.3) | SC-I-6 (10) |
| 116 | Invention | (36) | Oil-10 (0.3) | SC-II-1 (10) |
| 117 | Invention | (36) | Oil-10 (0.3) | SC-II-2 (10) |
| 118 | Invention | (36) | Oil-10 (0.3) | SC-III-1 (10) |
| 119 | Invention | (36) | Oil-10 (0.3) | SC-IV-2 (10) |
| 120 | Invention | (36) | Oil-10 (0.3) | SC-V-1 (10) |
| 121 | Invention | (36) | Oil-10 (0.3) | SC-II-1 (30) |
| 122 | Invention | (36) | Oil-10 (0.3) | SC-II-2 (30) |
| 123 | Invention | (36) | Oil-10 (0.3) | SC-V-1 (30) |
| 124 | Invention | (36) | Oil-10 (0.3) | SC-II-1 (5) |
| 125 | Invention | (37) | Oil-10 (0.3) | SC-II-1 (10) |

The following development processing-A was performed in this example. In the processing, a running processing was performed until the replenishing amount reaches five times the tank volume using samples 101 and 126 in a ratio of 1:1, 60% of which were fully exposed to white light.

| | | Tempera- | Tank | Replenishment |
|---|---|---|---|---|
| Processing Step | Time | ture | volume | rate |
| 1st development | 6 min | 38° C. | 195 L | 2,200 mL/m² |
| 1st washing | 2 min | 38° C. | 55 L | 4,000 mL/m² |
| Reversal | 2 min | 38° C. | 90 L | 1,100 mL/m² |
| Color development | 6 min | 38° C. | 180 L | 1,500 mL/m² |
| Pre-bleaching | 2 min | 38° C. | 70 L | 1,100 mL/m² |
| Bleaching | 6 min | 38° C. | 160 L | 220 mL/m² |
| Fixing | 4 min | 38° C. | 120 L | 1,100 mL/m² |
| 2nd washing | 4 min | 38° C. | 100 L | 4,000 mL/m² |
| Final rinsing | 1 min | 25° C. | 45 L | 1,100 mL/m² |

The compositions of respective solution were those as set forth below:

| <1st developer> | <Tank solution> | | <Replenisher> | |
|---|---|---|---|---|
| Nitrilo-N,N,N-trimethylene | 1.5 | g | 1.5 | g |
| phosphonic acid · | | | | |
| pentasodium salt | | | | |
| Diethylenetriamine | 2.0 | g | 2.0 | g |
| pentaacetic acid · | | | | |
| pentasodium salt | | | | |
| Sodium sulfite | 30 | g | 30 | g |
| Hydroquinone · potassium | 20 | g | 20 | g |
| monosulfonate | | | | |
| Potassium carbonate | 15 | g | 20 | g |
| Potassium bicarbonate | 12 | g | 15 | g |
| 1-phenyl-4-methyl-4- | 1.5 | g | 2.0 | g |
| hydroxymethyl-3- | | | | |
| pyrazolidone | | | | |
| Potassium bromide | 2.5 | g | 1.4 | g |
| Potassium thiocyanate | 1.2 | g | 1.2 | g |
| Potassium iodide | 2.0 | g | — | |
| Diethyleneglycol | 13 | g | 15 | g |
| Water to make | 1,000 | mL | 1,000 | mL |
| pH | 9.60 | | 9.60 | |

The pH was adjusted by sulfuric acid or potassium hydroxide.

| <Reversal solution> | <Tank solution> | | <Replenisher> |
|---|---|---|---|
| Nitrilo-N,N,N-trimethylene | 3.0 | g | the same as |
| phosphonic acid · | | | tank solution |
| pentasodium salt | | | |
| Stannous chloride · dihydrate | 1.0 | g | |
| p-aminophenol | 0.1 | g | |
| Sodium hydroxide | 8 | g | |
| Glacial acetic acid | 15 | mL | |
| Water to make | 1,000 | mL | |
| pH | 6.00 | | |

The pH was adjusted by acetic acid or sodium hydroxide.

| <Color developer> | <Tank solution> | | <Replenisher> | |
|---|---|---|---|---|
| Nitrilo-N,N,N-trimethylene | 2.0 | g | 2.0 | g |
| phosphonic acid · | | | | |
| pentasodium salt | | | | |
| Sodium sulfite | 7.0 | g | 7.0 | g |
| Trisodium phosphate · | 36 | g | 36 | g |
| dodecahydrate | | | | |
| Potassium bromide | 1.0 | g | — | |
| Potassium iodide | 90 | mg | — | |
| Sodium hydroxide | 3.0 | g | 3.0 | g |
| Citrazinic acid | 1.5 | g | 1.5 | g |
| N-ethyl-N-(β-methanesulfon | 11 | g | 11 | g |
| amidoethyl)-3-methyl-4 | | | | |
| aminoaniline · 3/2 sulfuric | | | | |
| acid · monohydrate | | | | |
| 3,6-dithiaoctane-1,8-diol | 1.0 | g | 1.0 | g |
| Water to make | 1,000 | mL | 1,000 | mL |
| pH | 11.80 | | 12.00 | |

The pH was adjusted by sulfuric acid or potassium hydroxide.

| <Pre-bleaching solution> | <Tank solution> | | <Replenisher> | |
|---|---|---|---|---|
| Ethylenediaminetetraacetic | 8.0 | g | 8.0 | g |
| acid · sodium salt · | | | | |
| dihydrate | | | | |
| Sodium sulfite | 2.0 | g | 3.0 | g |
| 1-thioglycerol | 0.4 | g | 0.4 | g |
| Formaldehyde sodium | 30 | g | 35 | g |
| bisulfite adduct | | | | |
| Water to make | 1,000 | mL | 1,000 | mL |
| pH | 8.00 | | 7.50 | |

The pH was adjusted by acetic acid or sodium hydroxide.

| <Bleaching solution> | <Tank solution> | | <Replenisher> | |
|---|---|---|---|---|
| Ethylenediamlnetetraacetic | 2.0 | g | 4.0 | g |
| acid · disodium salt · | | | | |
| dihydrate | | | | |
| Ethylenediaminetetraacetic | 120 | g | 240 | g |
| acid · Fe(III) · ammonium · | | | | |
| dihydrate | | | | |
| Potassium bromide | 100 | g | 200 | g |
| Ammonium nitrate | 10 | g | 20 | g |
| Water to make | 1,000 | mL | 1,000 | mL |
| pH | 5.70 | | 5.50 | |

The pH was adjusted by nitric acid or sodium hydroxide.

| <Fixing solution> | <Tank solution> | | <Replenisher> |
|---|---|---|---|
| Ammonium thiosulfate | 80 | g | the same as |
| | | | tank solution |
| Sodium sulfite | 5.0 | g | |
| Sodium bisulfite | 5.0 | g | |
| Water to make | 1,000 | mL | |
| pH | 6.60 | | |

The pH was adjusted by acetic acid or ammonia water.

| <Stabilizer> | <Tank solution> | | <Replenisher> | |
|---|---|---|---|---|
| 1,2-benzoisothiazoline-3-one | 0.02 | g | 0.03 | g |
| Polyoxyethylene-p-monononyl | 0.3 | g | 0.3 | g |
| phenylether | | | | |
| (average polymerization degree = 10) | | | | |
| Polymaleic acid | 0.1 | g | 0.15 | g |
| (average molecular weight = 2,000) | | | | |
| Water to make | 1,000 | mL | 1,000 | mL |
| pH | 7.0 | | 7.0 | |

Note that in the development processing step, the solution of each bath was continuously circulated and stirred, and at the bottom of each tank was provided with a bubbling pipe having small apertures of 0.3 mm diameter in an interval of 1 cm, and nitrogen gas was bubbled through the apertures to stir the solution. Bubble mixing was not performed in the pre-bleaching bath and the second washing bath.

(Evaluation of Samples)

(Evaluation of White Background)

Samples 101 to 125 were processed into 135 size, and then subjected to development processing-A. described above after their 1-second exposure outside in the sun in daytime, and the density was subsequently measured. Thereafter, the samples were stored for 10 days under conditions including a temperature of 30° C. and a humidity of 100%, and then the density (status A) was measured again. The higher the density after storage in comparison with that before storage, the more the coloring of a white background and the more unfavorable it is. The results are shown in Table 4 using the increase in magenta density.

TABLE 4
Evaluation results

| | | Coloring in white |
|---|---|---|
| | | background |
| | | (Increased value of |
| | | magenta density) |
| | | Development |
| Sample | Remarks | processing-A |
| 101 | Comparison | 0 |
| 102 | Comparison | 0.020 |
| 103 | Invention | 0.010 |
| 104 | Invention | 0.010 |
| 105 | Invention | 0.005 |
| 106 | Invention | 0.005 |
| 107 | Invention | 0.005 |
| 108 | Invention | 0.010 |
| 109 | Invention | 0.010 |
| 110 | Invention | 0.010 |
| 111 | Invention | 0.010 |
| 112 | Invention | 0.005 |
| 113 | Invention | 0.005 |
| 114 | Invention | 0.005 |
| 115 | Invention | 0 |
| 116 | Invention | 0 |
| 117 | Invention | 0 |
| 118 | Invention | 0 |
| 119 | Invention | 0 |
| 120 | Invention | 0 |
| 121 | Invention | 0 |
| 122 | Invention | 0 |
| 123 | Invention | 0 |
| 124 | Invention | 0 |
| 125 | Invention | 0 |

Table 4 shows that, in the case where no inhibitor of the present invention was present, the execution of development processing-A caused coloring of a white background into magenta after storage at high humidity (sample 102).

In contrast, samples to which an inhibitor of the present invention was added had reduced stain.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A silver halide color photographic material comprising at least one lightsensitive emulsion layer on a support, wherein the material contains
at least one cyan coupler represented by the following general formula (CC-1) and
at least one compound selected from the group consisting of compounds represented by the following general formulas (SC-I), (SC-II), (SC-III), (SC-IV) and (SC-V): 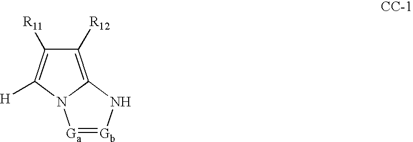
wherein Ga and Gb represent —C(R₁₃)═or —N═, provided that when Ga represents —N═, Gb represents —C(R₁₃)═ and when Ga represents —C(R₁₃)═, Gb represents —N═; each of R₁₁ and R₁₂ represents an electron-withdrawing group having a Hammett substituent constant σp of 0.20 or more and 1.0 or less; and R₁₃ represents a substituent; 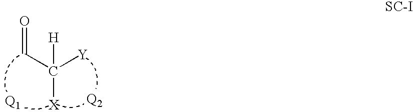
wherein Y represents a carbonyl group or a sulfonyl group; Q₁ and Q₂ each represent a substituted or unsubstituted non-metallic atomic group capable of forming a 5- or 6-membered ring; and X represents C—Rₓ or a nitrogen atom, wherein Rₓ represents a hydrogen atom or a substituent; 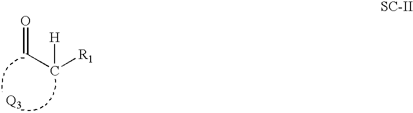
wherein Q₃ represents a substituted or unsubstituted non-metallic atomic group capable of forming a 5- or 6-membered ring; and R₁ represents a substituted or unsubstituted aryl group or a substituted carbonyl group; 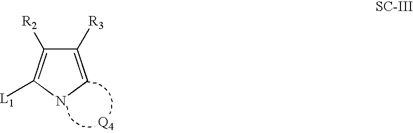
wherein Q₄ represents a substituted or unsubstituted non-metallic atomic group capable of forming a 5- or 6-membered ring; R₂ and R₃ each represent a substituent; and L₁ represents a group that does not leave in its reaction with an aromatic primary amine color developing agent; 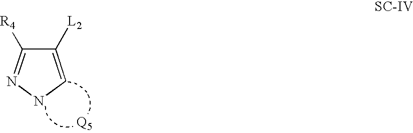
wherein Q₅ represents a substituted or unsubstituted non-metallic atomic group capable of forming a 5- or 6-membered ring; R₄ represents a substituent; and L₂ represents a group that does not leave in its reaction with an aromatic primary amine color developing agent; 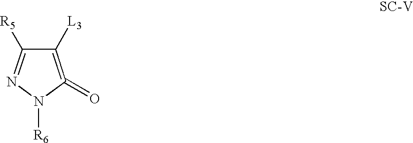
wherein R₅ and R₆ each represent a substituent; and L₃ represents a group that does not leave in its reaction with an aromatic primary amine color developing agent.

2. The silver halide color photographic material according to claim 1, wherein in the general formula (SC-I),
Q₁ represents *—O—C— or *—C—C—, wherein the bonding with * is attached to the carbon atom of the carbonyl group in the general formula (SC-I), and each of the carbon atom(s) of the *—O—C— or *—C—C— corresponding to Q₁ is unsubstituted;
Q₂ represents —C—C—C—, wherein each of the carbon atoms of the —C—C—C— corresponding to Q₂ is unsubstituted or substituted with an aliphatic group; and
X represents C—H.

3. The silver halide color photographic material according to claim 1, wherein in the general formula (SC-II),
Q₃ represents *—O—C—C— or *—C—C—C—, wherein the bonding with * is attached to the carbon atom of the carbonyl group in the general formula (SC-II), and each of the carbon atom(s) of the *—O—C—C— or *—C—C—C— corresponding to Q₃ is unsubstituted or a benzene ring is fused to the carbon atoms of the *—O—C—C— or *—C—C—C— corresponding to Q₃; and
R₁ represents a substituted carbonyl group whose substituent is selected from a group consisting of a substituted or unsubstituted anilino group, substituted or unsubstituted alkoxy group and substituted or unsubstituted aryloxy group.

4. The silver halide color photographic material according to claim 1, wherein in the general formula (SC-III),
Q₄ represents *—N═C(R₄₁)—NH— or *—C(R₄₁)═N—NH—, wherein the bonding with * is attached to the nitrogen atom of the pyrrole ring in the general formula (SC-III), and R₄₁ represents a substituted or unsubstituted aryl group or a substituted or unsubstituted aliphatic group;
R₂ represents a cyano group;
R₃ represents an aliphatic oxycarbonyl group or heterocyclic oxycarbonyl group; and
L₁ represents an unsubstituted aliphatic group.

5. The silver halide color photographic material according to claim 1, wherein in the general
Q₅ represents *—N═C(R₅₁)—NH— or *—C(R₅₁)═N—NH—, wherein the bonding with * is attached to the nitrogen atom of the pyrazole ring in the general formula (SC-IV), and wherein R₅₁ represents a substituted or unsubstituted aryl group or substituted or unsubstituted aliphatic group;
R₄ represents an aliphatic group or alkoxy group; and
L₂ represents an unsubstituted aliphatic group.

6. The silver halide color photographic material according to claim 1, wherein in the general formula (SC-V),
R₅ and R₆ each independently represents a substituted or unsubstituted aliphatic group, substituted or unsubstituted alkoxy group or substituted or unsubstituted aryl group; and
L₃ represents an unsubstituted aliphatic group.

7. A method of reducing magenta stain in a silver halide color photographic material, wherein the method comprises allowing a silver halide color photographic material comprising at least one lightsensitive emulsion layer on a support to contain at least one cyan coupler represented by the general formula (CC-1) and at least one compound selected from the group consisting of compounds represent by the general formulas (SC-I), (SC-II), (SC-III), (SC-IV) and (SC-V): 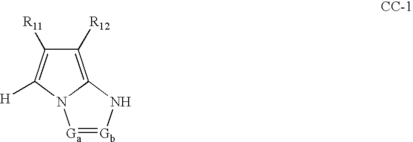
wherein Ga and Gb represent —C(R₁₃)═or —N═, provided that when Ga represents —N═, Gb represents —C(R₁₃)═ and when Ga represents —C(R₁₃)═, Gb represents —N═; each of R₁₁ and R₁₂ represents an electron-withdrawing group having a Hammett substituent constant up of 0.20 or more and 1.0 or less; and R₁₃ represents a substituent; 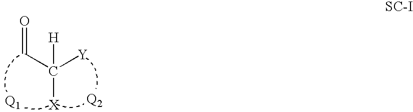
wherein Y represents a carbonyl group or a sulfonyl group; Q₁ and Q₂ each represent a substituted or unsubstituted non-metallic atomic group capable of forming a 5- or 6-membered ring; and X represents C—Rₓ or a nitrogen atom, wherein Rₓ represents a hydrogen atom or a substituent; 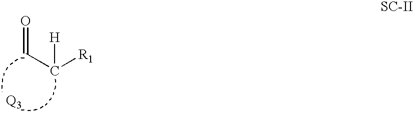
wherein Q₃ represents a substituted or unsubstituted non-metallic atomic group capable of forming a 5- or 6-membered ring; and R₁ represents a substituted or unsubstituted aryl group or a substituted carbonyl group; 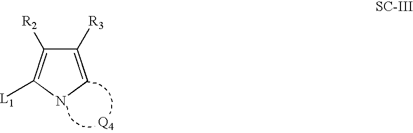
wherein Q₄ represents a substituted or unsubstituted non-metallic atomic group capable of forming a 5- or 6-membered ring; R₂ and R₃ each represent a substituent; and L₁ represents a group that does not leave in its reaction with an aromatic primary amine color developing agent; 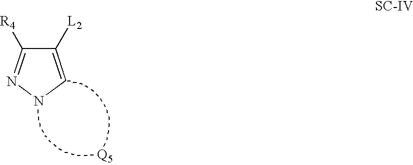
wherein Q₅ represents a substituted or unsubstituted non-metallic atomic group capable of forming a 5- or 6-membered ring; R₄ represents a substituent; and L₂ represents a group that does not leave in its reaction with an aromatic primary amine color developing agent; 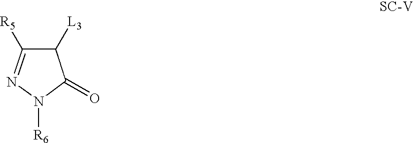
wherein R₅ and R₆ each represent a substituent; and L₃ represents a group that does not leave in its reaction with an aromatic primary amine color developing agent.

8. A method of using a compound selected from a group consisting of compounds represent by the general formulas (SC-I), (SC-II), (SC-III), (SC-IV) and (SC-V) according to claim 1 for reducing magenta stain in a silver halide color photographic material comprising, on a support, at least one lightsensitive emulsion layer containing at least one cyan coupler represented by the general formula (CC-1) according to claim 1.
